(19) United States
(12) Patent Application Publication
(10) Pub. No.: US 2011/0103236 A1
(43) Pub. Date: May 5, 2011

(54) TRANSMISSION METHOD OF CODE DIVISION MULTIPLEXING AND MULTIPLE ACCESS

(75) Inventor: Daoben Li, Shenzhen (CN)

(73) Assignee: Research Institute of Tsinghua University in Shenzhen, Shenzhen (CN)

(21) Appl. No.: 12/558,538

(22) Filed: Sep. 13, 2009

(51) Int. Cl. H04J 13/00; H04L 12/26

(52) U.S. Cl. 370/252; 370/479

(57) ABSTRACT

The present invention relates to a code multiplexing method which employs the parallel linear or nonlinear coding whose coding rate is more than one for the multiplexing transmission. When the coding rate is more than one, the parallel input bits sequence and the parallel output bits sequence have a one-to-one relationship. The aforementioned parallel coding method is beyond the finite field, and all the parallel coding polynomial set is coprime with each other. The method includes the following steps: compositing the encoding matrix B which contains K coding vectors, forming K parallel data transmission paths which correspond to the K coding vectors, processing the convolutional coding between each data path and the corresponding coding vector where the coding constraint length is L, forming the N-dimensional output vectors by summing the result of the K convolutional coding data paths, receiving the aforementioned N-dimensional coding output vectors and taking the sequence detection. The abovementioned K, N, L are the basic parameters for the parallel coding. The present invention can greatly boost the system capacity and enhance the frequency efficiency by using the linear or nonlinear coding transmission whose coding rate is more than one.

### BACKGROUND OF THE INVENTION

1. Field of the Invention

This invention relates to the field of mobile communications, especially on issues of parallel multiplexing or multiple access transmissions. Specifically, it is on a transmission method of code division multiplexing and multiple access.

2. Description of the Related Art

IMT (international mobile telecommunications)—Advanced, the new standard for the future mobile communications, is currently proposed by ITU (international telecommunications union), and many International Standardization Organizations are all actively targeting the goal of future mobile communication, and scheduling the timetable for the system implementation. ITU predicts that the future system with the new standard can support the peak rate of up to 100 Mbps in the high-speed mobile and harsh transmission environment and 1 Gbps in low-speed mobile and good transmission environment and meet the needs of the global personal communications around the year 2010.

However, the frequency spectrum resources used for mobile communications are very limited. It is very difficult to meet the explosive growth of the communication traffic requirements by the current technical solutions or even the theoretical concepts with such limited resources, which requires the new innovation and breakthrough in wireless communications from the theoretical and technical perspective to solve the problems, so that the spectrum efficiency, capacity and data rate can be improved in at least one order of magnitude.

Multiplexing is a way when one channel is used by multiple information sources simultaneously, while Multiple Access is a way when one channel is used by many users. Although Multiplexing and Multiple Access deal with different issues, the objective is the same, which is to share or allocate the shared channel capacity. Thus, the present invention will handle them as the same issue.

The basic information theory tells us that when a channel is allocated, there is a channel capacity which is the maximum transmission rate C. The data rate of a practical system can only try to reach C but can not exceed. But that is just used for a single traffic source and a single user with single address. When it comes to a shared channel capacity for the multi-source or multi-user, the information theory also points out that, parallel multiplexing (or multiple access) transmission is an important way to improve the system capacity and spectrum efficiency, and there is only one optimal solution called Waveform Division Multiplexing (Multiple Access). Since the Waveform is generated by the coding method generally, it is also known as the coding or code division multiplexing (or multiple access) in more technical way. For the optimal coding multiplexing (or multiple access), although the single sub-channel coding rate can not be more than C, the sum of the rate of the multiple sub-channels, namely, the total data rate can exceed C in theory, which also means that these encoded sub-channels can share channel capacity. Any other channel division method can only allocate the channel capacity rather than share it, meaning that the transmission rate of each sub-channel can not exceed channel capacity. Thus, the optimal way would be coding multiplexing (or multiple access). There are four basic parallel multiplexing (or multiple access) ways:

1) Traditional Code Division Multiplexing (or Code Division Multiple access). Although it is a multiplexing (or multiple access) transmission technology in coding domain, there is an orthogonal relationship to that with no coding constraints among signature sequences. In theory, it is a kind of multiplexing (or multiple access) method which makes use of the orthogonal waveforms to allocate (decompose) the channel capacity without a coding gain. Strictly speaking, it is totally different with the coding multiplexing (or multiple access) method described in this invention.

2) Time Division Multiplexing (or Time Division Multiple access). It is a multiplexing (or multiple access) transmission technology in time domain. Unfortunately, it does not allow any overlap between the sub slots. In theory, it is a kind of multiplexing (or multiple access) method which makes use of orthogonal waveforms to allocate (decompose) the channel capacity, and is a simple way of coding multiplexing (or multiple access) with no coding gain.

3) Frequency Division Multiplexing (or Frequency Division Multiple access) and Orthogonal Frequency Division Multiplexing (Orthogonal Frequency Division Multiple access). They are two ways of parallel multiplexing (or multiple access) in frequency domain. Especially, the capacity and spectral efficiency of the latter is nearly double the former under the same conditions. Unfortunately, the spectrum of their sub-carriers demonstrates the orthogonal relationship with no coding constraints. In theory, it is a kind of multiplexing (or multiple access) method which makes use of orthogonal waveforms to allocate (decompose) the channel capacity. Besides, it's limited to improve system spectrum efficiency for OFDM (OFDMA) only. However, as there is no better technology in the frequency domain, OFDM (OFDMA) is still a hot topic in the engineering field, which is considered as the only way for parallel multiplexing (or multiple access) transmission in frequency domain with high capacity. They are also simple solutions of coding multiplexing (or multiple access) with no coding gain.

4) Physical Space Division Multiplexing (SDM) (or Physical Space Division Multiple Access) and Statistical Space Division Multiplexing (also called multiple input, multiple output, multiple antenna in the rich scattering environment) MIMO transmission technology. They can significantly improve system capacity and spectrum efficiency, but they are very harsh in the channel spread conditions with very low performance. The former requires that the channel must be poor scattering, or its angular spread of the channel remains very small which is close to 0°. The latter requires a rich channel scattering, or its angular spread of the channel remains very large which is close to 360°. Otherwise, for their space division gain, the former will increase gradually with the increase of channel angle spread, and the latter will decrease gradually till loss with the decrease of channel angle spread. Furthermore, the space sub-channels demonstrate the orthogonal or independent relationship with no coding constraints. In theory, they are multiplexing (or multiple access) methods which make use of orthogonal or independent airwaves to allocate (decompose) the channel capacity, and are also the simple ways of coding multiplexing (or multiple access) with no coding gain.

The above mentioned technologies are the simple coding (or multiple access) methods with no coding gain, which can only allocate channel capacity.

As well known, the error correction capability of channel coding depends on code rate less than one (the code rate generally means the ratio of the transmission data bits over corresponding coding symbol bits). The lower the code rate is, the stronger the error correction capability of the code and the higher the system transmission reliability will be. However, it costs system bandwidth which expands proportionally and spectrum efficiency which decreases proportionally.

Although in theory we can use the encoding method whose code rate can be higher than one which improves the system spectral efficiency, no one cares about this kind of coding in the past. Because it was generally thought that the encoding “has no redundancy”, “absolutely have no error correction capability” and “can't provide one-to-one relationship between the input and output sequences”.

The existing multiplexing technology (or multiple access technology) is a linear encoding multiplexing that has no coding gain and tits bound length is 1. Furthermore, the code rate of most technologies is more than 1 except the traditional CDM (CDMA) technology whose code rate is less than 1. Moreover, the traditional multi-level modulation techniques with high spectrum efficiency such as pulse amplitude modulation PAM, multi-phase modulation PM, quadrature amplitude modulation QAM, and some other response modulation etc, are linear encoding multiplexing that has no coding gain, bound length being 1, and code rate more than 1. But their multiplexing (or multiple access) signals either separate each other or have no overlapping (that is the somehow “orthogonal”), such as multiplexing (multiple access) technology TDM (TDMA), SDM (SDMA), FDM (FDMA) and so on, or multi-level modulation techniques such as PAM, PM, QAM and so on, or CDM (CDMA), OFDM (OFDMA), MIMO etc whose signals are orthogonal or independent though being overlapping with each other. However, these would lead to the complete loss of Code Constraint Relation (CCR) which means their Code Constraint Length is only equal to 1 and can not provide any coding gain.

From the following two simplest examples, we can understand whether there is one-to-one relationship or not when the code rate is higher than 1 for the traditional linear convolutional coding (when the input data and encoding matrix elements are both in a “finite field”):

### Example 1

### K=2, N=1, L=2, Q=2

$${U}_{n} = [ \begin{matrix}{\tilde{u}}_{n , 0} \\ {\tilde{u}}_{n , 1}\end{matrix} ] , {\tilde{u}}_{n , k} ∈ \{ + , - \} , k = 0 , 1 ;$$

Parallel Data Input:

$${B}_{0} = [ \begin{matrix}+ \\ +\end{matrix} ] , {B}_{1} = [ \begin{matrix}+ \\ -\end{matrix} ] ;$$

Parallel Encoding Structure:

b₀^{T}=[+,+],b₁^{T}=[+,−];

\tilde{v}ₙ^{T}=Uₙ^{T}B₀+Uₙ₋₁^{T}B₁,

Coding Output:

If the input and output of the encoding sequence have one-to-one relationship, the spectrum efficiency of output code will be twice of the input code. The number of steady state is totally 2^{QK(L-1)}=2²=4. They are: {+,+};{+,−};{−,+};{−,−}; and the initial and final state is all-zero, that is {0,0}. The system has no transition state.

Each steady state (including the initial state) can transfer to all the other four steady states, and the four steady states can transfer to the final state {0,0}. The Trellis diagram accordingly is shown in FIG. 1.

We examine example 1 with encoding polynomial and check whether there is one-to-one relationship, as follows:

Tap coefficient polynomial is

b₀(x)=1+x,b₁(x)=1−x, (5)

Then, coding output is

\tilde{v}(x)=\tilde{u}₀(x)b₀(x)+\tilde{u}₁(x)b₁(x), (5′)

Because the constraint length is 2, it's enough to examine the case with data length being 2. When data length is longer than 2, the first input data is bound to leave the encoder and not involved in the encoding operations. The parallel input data set {ũ₀(x)},{ũ₁(x)} both contain four elements, that is:

{ũₖ₀(x),ũₖ₁(x),ũₖ₂(x),ũₖ₃(x)}={1+x,1−x,−1+x,−1−x},k=0,1ₒ

The corresponding set of two coded output {\tilde{v}₀(x)\tilde{v}₁(x)} also have four elements respectively, that is:

{\tilde{v}ₖ₀(x),\tilde{v}ₖ₁(x),\tilde{v}ₖ₂(x),\tilde{v}ₖ₃(x)},k=0,1

Where, there are two paths whose coding output is 0. One of them is \tilde{v}_{0,1}+\tilde{v}_{1,3}=0 and its state transition relations is:

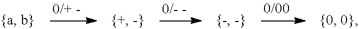

The other is \tilde{v}_{0,2}+\tilde{v}_{1,0}=0, and its state transition relations is:

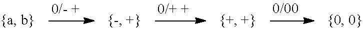

Where, {a,b} can be one of the state {0,0},{+,+},{−,−}, and coding output of the two paths (including path metric and branch metric) are the same. In addition, though we can not find any other path whose coding output is equal, we are sure that it has no one-to-one relationship. Trellis diagram in FIG. 1 confirms this fact.

Whether it is because the code of example 1 being too short so that the output coding number of the code word is too small which results in no one-to-one relationship between the coded output and input code, or there might be one-to-one relationship if we choose longer code, we can look at an example with a traditional linear convolutional coding structure with longer coding constraint length as follows:

### Example 2

### K=2, N=1, L=3, Q=2

$${U}_{n} = [ \begin{matrix}{\tilde{u}}_{n , 0} \\ {\tilde{u}}_{n , 1}\end{matrix} ] , {\tilde{u}}_{n , k} ∈ \{ + , - \} , k = 0 , 1 ;$$

Parallel Data Input:

$${B}_{0} = [ \begin{matrix}+ \\ +\end{matrix} ] , {B}_{1} = [ \begin{matrix}+ \\ -\end{matrix} ] , {B}_{2} = [ \begin{matrix}- \\ +\end{matrix} ] ;$$

Parallel Encoding Structure:

\tilde{v}ₙ^{T}=Uₙ^{T}B₀+Uₙ₋₁^{T}B₁+Uₙ₋₂^{T}B₂, (6)

Encoding Output:

Obviously, after such parallel coding, if there is one-to-one relationship between the encoding input and output sequence, the spectrum efficiency of the coding output will be twice the input. The steady state number is totally 2^{QK(L-1)}=2⁴=16, that is:
{+,+,+,+};{+,+,+,−};{+,+,−,+};{+,+,−,−};
{+,−,+,+};{+,−,+,−};{+,−,−,+};{+,−,−,−};

{−,+,+,+};{−,+,+,−};{−,+,−,+},{−,+,−,−};

{−,−,+,+};{−,−,+,−};{−,−,−,+};{−,−,−,−};

The initial and the final state are both (0,0,0,0); there are four former transition states, which are:

{0,0+,+};{0,0+,−};{0,0−,+};{0,0−,−};

There are four kinds of latter transition states, which are:

{+,+,0,0};{+,−,0,0};{−,+0,0};{−,−,0,0};

The initial state {0,0,0,0} can transfer to the four former transition states {0,0,X,X}. The former transition state and every steady state can transfer to the other four steady states. Every four steady states can transfer to the same latter transition state {X,X,0,0}. The four latter transition states can only transfer to the final state {0,0,0,0}. Trellis diagram accordingly is shown in FIG. 2.

The encoding tap polynomial:

b₀(x)=1+x−x²,b₁(x)=1−x+x², (7)

The output coding polynomial:

\tilde{v}(x)=\tilde{u}₀(x)b₀(x)+\tilde{u}₁(x)b₁(x) (8)

Because the constraint length is 3, it's enough to examine the case with data length being 3. The parallel input data set {ũ₀(x)},{ũ₁(x)}, both contain eight elements, that is:

{\tilde{u}ₖ₀(x),\tilde{u}ₖ₁(x),\tilde{u}ₖ₂(x),\tilde{u}ₖ₃(x),\tilde{u}ₖ₄(x),\tilde{u}ₖ₅(x),\tilde{u}ₖ₆(x),\tilde{u}ₖ₇(x)}={1+x+x²,1+x−x²,1−x+x²,1−x−x²,−1+x+x²,−1+x−x²,−1−x+x²,−1−x−x²}k=0,1.

The corresponding coded output set {\tilde{v}₀(x)},{\tilde{v}₁(x)}, also have eight elements respectively, that is:

{\tilde{v}ₖ₀(x),\tilde{v}ₖ₁(x),\tilde{v}ₖ₂(x),\tilde{v}ₖ₃(x),\tilde{v}ₖ₄(x),\tilde{v}ₖ₅(x),\tilde{v}ₖ₆(x),\tilde{v}ₖ₇(x)}=k=0,1.

The total coding output is \tilde{v}(x)=\tilde{v}₀(x)+\tilde{v}₁(x), where, the coding output of the two paths is zero, and they are \tilde{v}₀₅(x)+\tilde{v}₁₁(x)=\tilde{v}₀₂(x)+\tilde{v}₁₆(x)=0. Because the code word is symmetrical, the zero output also means that the coding output of the two paths is consistent. From the above two examples, we can be certain that it does not have one-to-one relationship when the input data and elements of the encoding matrix are both located in the “finite field” for the traditional coding structure, even if the code rate exceeds 1 and the constraint length is longer. The reason lies in that the number of output codewords would be less than all the possible encoding input data even if the code rate exceeds 1 when the input data and encoding tap coefficients (and thus the output data) are both located in the “finite field”. Thus, there is no one-to-one relationship between the input and output.

We list the literatures as the reference of this invention:
(1) Principle of Digital Communication & Coding. Viterbi A J, Omura J K. McGraw_Hill, 1979;
(2) The Statistical Theory of Signal Detection and Estimation, Daoben Li, Science Press, 2005 Second Edition;
(3) PCT International patent applications, Application No. PCT/CN2006/001585, Invention Name: A Time Division Multiplexing Transmission Methods and Techniques;
(4) PCT International patent applications, Application No. PCT/CN2006/002012, Invention Name: A Frequency Division Multiplexing Transmission Methods and Techniques.

### SUMMARY OF THE INVENTION

One of the objective of the invention is to provide a transmission method of coding multiplexing. The method can improve significantly system capacity and spectral efficiency by using the general or specific parallel convolutional coding whose code rate exceeds 1 or other types of parallel coding.

The technical solution that can achieve one of the objectives of the present invention includes:

A coding multiplexing transmission method that uses parallel linear or non-linear code with coding rate more than 1. When the coding rate is higher than 1, there is one-to-one relationship between parallel encoding input sequence and output sequence.

The parallel coding described above is beyond the finite field, and the parallel encoding polynomias {\tilde{v}ₖ(x)},k=0,1, . . . , K−1, are coprime with each other.

The parallel encoding tap polynomials described above bₖ(x),k=0,1, . . . , K−1, are coprime.

The above-mentioned parallel code contains linear or nonlinear, broad or narrow parallel convolutional coding with code ratio more than 1 or other types of broad or narrow parallel coding (any code except convolutional code).

The tap coefficients of the parallel coding are the sample value of complex or real Gaussian distribution random variables; the sample value of uniformly distributed random variables within a range of the complex or real plane; or {a+jb},a,bε{0,±1,±2, . . . } or other limited non-integer real number; or the tap coefficient located at unit circle; or, on or above the real axis or imaginary axis.

The coding tap coefficient belongs to different or rotated or overlapped domains wherein the domains mean different or rotated or overlapped coding domains, different or rotated or overlapped spatial domains, different or rotated or overlapped frequency domains, different or rotated or overlapped time domains or the mixture of the above-mentioned domains.

The coding tap of the parallel coding polynomial with coprime coefficient should ensure that the codeword has the largest free distance.

The methods described as set forth above, include the following steps: compositing the encoding matrix B which contains K coding vectors; forming K parallel data transmission paths which correspond to the K coding vectors; performing the convolutional coding between each data path and the corresponding coding vector with coding constraint length L; forming the N-dimensional output vectors by summing the results of the K convolutional coding data paths; receiving the above mentioned N-dimensional coding output vectors and execute the sequence detection. The K, N, L, as set forth above, are the basic parameters for the parallel coding.

The other objective of the present invention is to provide a multiple access transmission method. The method adopts linear or nonlinear, general or specific parallel convolutional coding with code rate more than 1 or other types of parallel coding. Hence it can improve significantly the system capacity and spectral efficiency.

The technical solution that achieves another objective of the invention includes:

A coding multiplexing transmission method that uses parallel linear or non-linear code with coding rate over 1. When the coding rate is higher than 1, there is one-to-one relationship between parallel encoding input sequence and output sequence.

The parallel coding described above is beyond the finite field, and the parallel encoding polynomias {\tilde{v}ₖ(x)},k=0,1, . . . , K−1, are coprime with each other.

The parallel encoding tap polynomials described above bₖ(x),k=0,1, . . . , K−1, are coprime.

The parallel code as set forth above, contains: linear or nonlinear, broad or narrow parallel convolutional coding with code ratio more than 1 or other types of broad or narrow parallel coding (any code except convolutional code).

The tap coefficients of the parallel coding are: the sample value of complex or real Gaussian distribution random variables; the sample value of uniformly distributed random variables within a range of the complex or real plane; or {a+jb},a,bε{0,±1,±2, . . . } or other limited non-integer real number; or the tap coefficientl located at unit circle; or, on or above the real axis or imaginary axis.

The coding tap coefficient belong to different or rotated or overlapped domains wherein the domains mean different or rotated or overlapped coding domains, different or rotated or overlapped spatial domains, different or rotated or overlapped frequency domains, different or rotated or overlapped time domains or the mixture of the above-mentioned domains.

The coding tap of the parallel coding polynomial with coprime coefficient should ensure that the codeword has the largest free distance.

The above-mentioned methods include the following steps: compositing the encoding matrix B, which contains K coding vectors; forming K parallel data transmission paths which correspond to the K coding vectors; performing the convolutional coding between each data path and the corresponding coding vector with coding constraint length L; forming the N-dimensional output vectors by summing the result of the K convolutional coding data paths; receiving the above described N-dimensional coding output vectors and executing the sequence detection. The K, N, L as set forth above, are the basic parameters for the parallel coding.

The invention processes the destructive factors from external system as interference, and all the overlapping among interior signals (symbols) are regarded as coding constraints. Besides, the invention implements the parallel transmission of the multiple data streams and improves significantly the system capacity and spectral efficiency by seeking one-to-one relationship between the input and output sequence with code rate higher than 1.

### BRIEF DESCRIPTION OF THE DRAWINGS

For the full understanding of the nature of the present invention, reference should be made to the following detailed descriptions with the accompanying drawings in which:

FIG. 1 is the Trellis diagram of Example 1;

FIG. 2 is the Trellis diagram of Example 2;

FIG. 3 is a simulation figure of one preferred embodiment;

FIG. 4 is a simulation figure of another preferred embodiment;

FIG. 5 is the coding structure of Example 3.

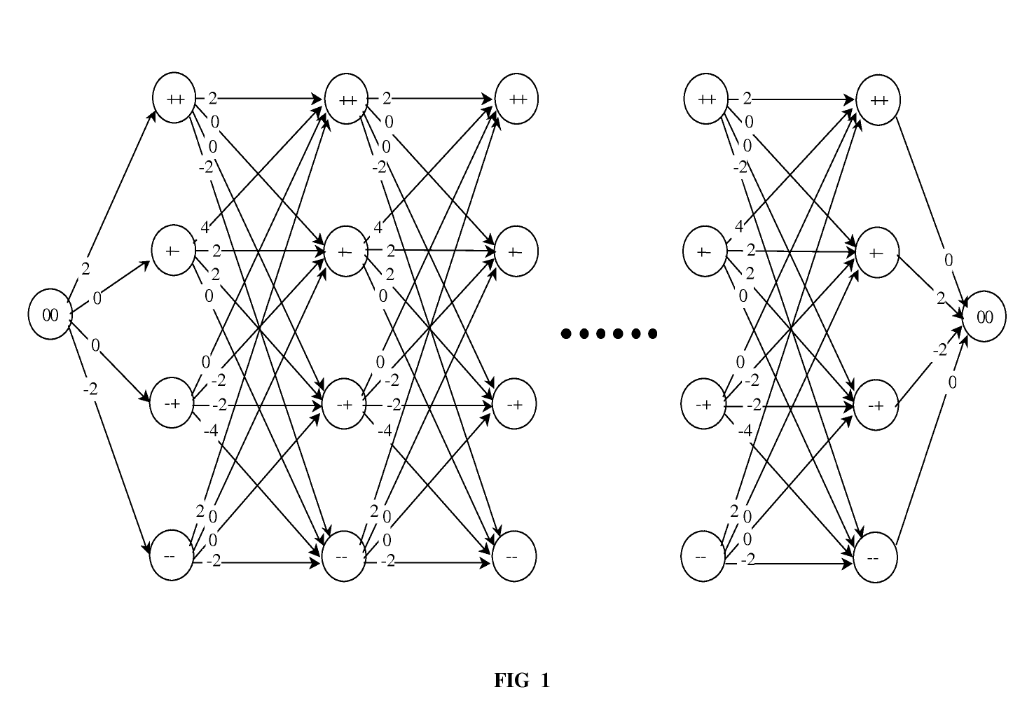

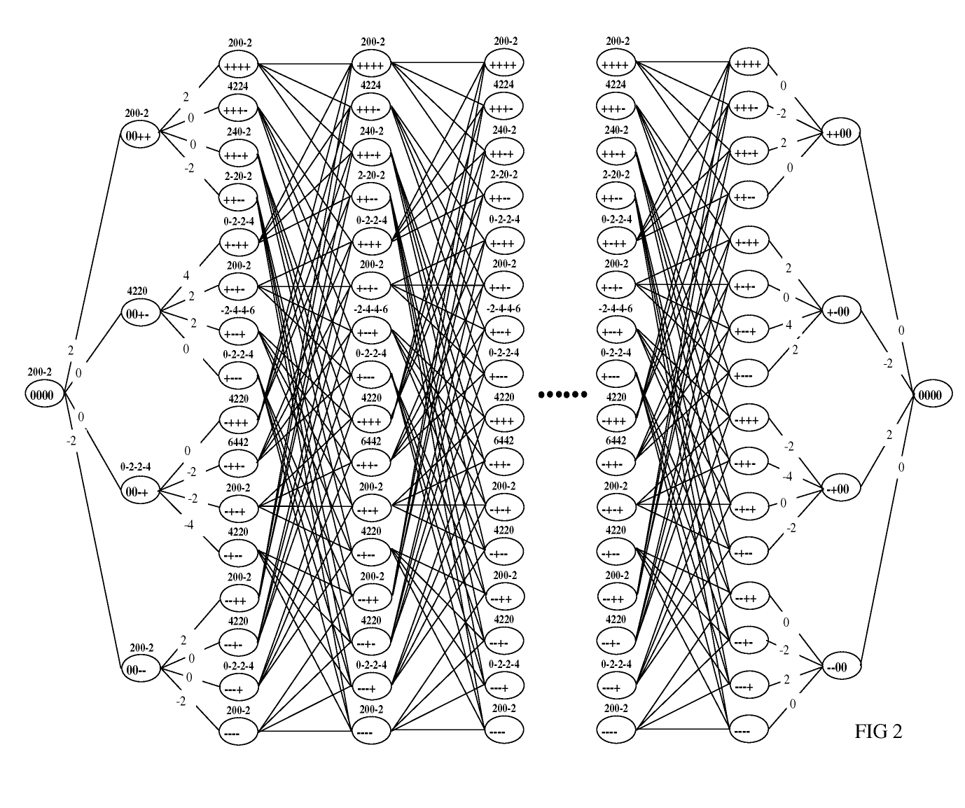

Like reference numerals refer to like parts throughout the several views of the drawings.

### DESCRIPTION OF THE PREFERRED EMBODIMENT

The invention can improve significantly system capacity and spectral efficiency by using the general or specific parallel convolutional coding with code rate more than 1 or other types of parallel coding. The general convolutional coding algorithm used in OVCDM (OVCDMA) (overlapped code division multiplex or multiple access) of the invention is introduced as follows:

$${V}_{n}^{T} = F \{ [ {\sum }_{l = 0}^{Min ( n , L - 1 )} {U}_{n - l}^{T} {B}_{l} ] \} , \qquad ( 1 )$$

This is linear coding which completely corresponds to the monotonic invertible non-linear function F().

$${\tilde{v}}_{n}^{T} = {F}^{- 1} ( {V}_{n} ) = {\sum }_{l = 0}^{Min ( n , L - 1 )} {U}_{n - l}^{T} {B}_{l} , \qquad ( 2 )$$

Where, F() is a monotonic invertible non-linear function where monotonic means one-to-one relationship and invertible means the existence of inverse function F⁻¹{F()}=. When F()=, it is linear OVCDM, and Vₙ=\tilde{v}ₙ.

Vₙ,\tilde{v}ₙ are respectively non-linear and the corresponding linear coding output vectors (N-dimensional). In order to simplify the implementation, we only study the linear OVCDM, as set forth above. When encoding matrix B is the same, the characteristics of non-linear codes are different for diverse monotonic inversible non-linear functions F(). Otherwise, for the given F(), the optimal encoding matrix B is different from the linear codes in general.

Uₙ=[ũ_{n,0} ũ_{n,1} . . . ũ_{n,K-1}]^{T} is a parallel transmission vector of K dimensional complex data, where, the element ũ_{n,k} represents the parallel complex transmission data of k(k=0.1, . . . , K−1)-th coding branch in the n-th time interval tε[nT_{S},(n+1)T_{S});

ũ_{n,k}εχ, χ is a set of Q-multiple binary data, or more generally a set of Hermitian data. Each element ũ of Hermitian set has its negative element −ũ, conjugate element ũ*, negatively conjugate element −ũ*, the size of χ (the number of elements) is 2 Q (Q equals to the number of bits each symbol carries);

Uₙεχ^{K}, where the size of data vector set χ^{K} is 2 QK, it is a KQ-multiple binary data set or a Q-multiple Hermitian set;

$$B = [ {B}_{0} , {B}_{1} , … , {B}_{L - 1} ] = [ \begin{matrix}{b}_{0}^{T} \\ {b}_{1}^{T} \\ ⋮ \\ {b}_{K - 1}^{T}\end{matrix} ]$$

is the encoding matrix (K×LN order);

Bₗ is the encoding matrix of the l(l=0,1, . . . , L−1)-th tap (K×N order);

$${B}_{l} = [ \begin{matrix}{b}_{0 , l}^{T} \\ {b}_{1 , l}^{T} \\ ⋮ \\ {b}_{K - 1 , l}^{T}\end{matrix} ] ,$$

bₖ^{T}=[b_{k,0}^{T} b_{k,1}^{T} . . . b_{k,L-1}^{T}], is the parallel coding vector of the k(k=0,1,2 . . . K−1)-th path (LN-dimension);

Here, b_{k,l}^{T}=[b_{k,0}^{l} b_{k,1}^{l} . . . b_{k,N-1}^{l}], is the l(l=0,1,2, . . . , L−1)-th vector of coding tap coefficient (N-dimension) of the k(k=0,1,2 . . . K−1)-th parallel coding branch;

This is a convolutional coding model of generalized non-linear vector, which is a typical parallel convolutional coding [1] with code rate K/N when K≦N, L>1, and is a typical block coding when L=1. The code rate is higher than 1 when K>N, and that is the OVCDM (OVCDMA) presented in this invention. The maximum spectrum efficiency is obtained at the largest code rate K while N=1.

The traditional high-dimensional (multiple level) modulation technologies with higher spectrum efficiency such as PAM, PM, QAM are all the specific cases of linear OVCDM (OVCDMA), when input data ũ_{n,k}ε{+,−} is binary and the constraint length L equals 1. The encoding matrix is only column matrix which is respectively [1, 2, . . . , 2^{K-1}]^{T}, [1, e^{jπ/K}, . . . , e^{j(K-1)π/K}]^{T}, K=2, 3, . . . and [1,2, . . . , 2^{K-2/2},j,j2, . . . , j2^{K-2/2}]^{T}, K=1,4, . . . (the expression of QAM needs more constraints when K is odd). Obviously, partial response modulation is also the specific case of OVCDM (OVCDMA).

Furthermore, from the view of parallel coding, other multiplexing (multiple address) technologies such as TDM (TDMA), FDM and OFDM (FDMA and OFDMA), SDM (SDMA), statistic SDM-MIMO (namely the multiple input, multiple output and multiple antenna multiplexing in rich-scattering environments) etc also belong to the simple linear OVCDM (OVCDMA) with coding constraint length L=1 and code rate higher than 1. The encoding matrix is only column matrix where the coding elements are only the corresponding time slot, frequency slot and space slot, and the data input can be any modulated signal. While the traditional CDM (CDMA) is a simple linear OVCDM (OVCDMA) with constraint length L=1, code rate less than 1, each row of the encoding matrix constitutes the spreading signature sequence.

At last, it's important to note that the OVCDM system is the well known channel model of ISI (intersymbol interference) [2], when K=N=1, B=[\tilde{h}₀,\tilde{h}₁, . . . \tilde{h}_{L-1}], and \tilde{h}ₗ(l<0,1, . . . , L−1) is the sample value of system pulse response (including modulator, filter and channel response). The linear OVCDM system has the OVTDM system model [3] proposed in the previous patent by the present inventor, while B=[1,1, . . . 1] and the width of input symbols is L times the chip width of encoding matrix. Similarly, if the coding operation is processed in space domain or frequency domain, the linear OVCDM system has the OVSDM or OVFDM system model [4] proposed in the previous invention.

Thus, PAM, PM, QAM, partial response coding, the high spectrum efficiency modulation technologies, and the multiplexing (multiple address) technologies such as CDM (CDMA), TDM (TDMA), FDM (FDMA), OFDM (OFDMA), SDM (SDMA), MIMO, and the channel coding technologies such as convolutional coding (L>1), block coding (L=1), Trellis coding, Turbo coding, and ISI channel, OVTDM, OVSDM, OVFDM, and even the OVHDM are all specific cases of OVCDM (OVCDMA). Therefore, theoretically speaking, because of the constraint length of OVCDM (OVCDMA) longer than 1, especially with a bigger convolutional space, the optimal performance of corresponding field is surely better than others.

The polynomial of linear overlapped convolutional coding multiplexing (multiple access) is described as follows:

$${\tilde{v}}_{n}^{T} = {\sum }_{l = 0}^{Min ( n , L - 1 )} {U}_{n - l}^{T} {B}_{l} = {\sum }_{k = 0}^{K - 1} {\tilde{v}}_{k , n} = {\sum }_{k = 0}^{K - 1} {\sum }_{l = 0}^{Min ( n , L - 1 )} {\tilde{u}}_{k , n - l} {b}_{k , l}^{T} , \qquad ( 3 )$$

The encoding model is the same as that of the convolutional code, whose presentation of polynomials is shown below:

The k-th input data ũₖ=[ũ_{k,0},ũ_{k,1}, . . . , ũ_{k,n}, . . . ]^{T} k=0,1, . . . , K−1,

Polynomial of the K-th Path Input Data

$${\tilde{u}}_{k} ( x ) = {\tilde{u}}_{k , 0} + {\tilde{u}}_{k , 1} x + {\tilde{u}}_{k , 2} {x}^{2} + … + {\tilde{u}}_{k , n} {x}^{n} + … = {\sum }_{n = 0} {\tilde{u}}_{k , n} {x}^{n}$$

The Encoding Matrix

$$B = [ \begin{matrix}{b}_{0}^{T} \\ {b}_{1}^{T} \\ ⋮ \\ {b}_{K - 1}^{T}\end{matrix} ] ,$$

Polynomials of Encoding Matrix

$$B ( x ) = [ \begin{matrix}{b}_{0} ( x ) \\ {b}_{1} ( x ) \\ ⋮ \\ {b}_{K - 1} ( x )\end{matrix} ]$$

Where,

$${b}_{k} ( x ) = {\sum }_{l = 0}^{L - 1} {b}_{k , l}^{T} {x}^{l} ( k = 0 , 1 , … , K - 1 )$$

is the polynomial of k-th path coding, b_{k,l} are N-dimension vectors.

Polynomial of K-th Path Coding Output

\tilde{v}ₖ(x)=ũₖ(x)bₖ(x), (4)

Polynomial of Total Coding Output

$$\tilde{v} ( x ) = {\sum }_{k = 0}^{K - 1} {\tilde{v}}_{k} ( x ) = {\sum }_{k = 0}^{K - 1} {\tilde{u}}_{k} ( x ) {b}_{k} ( x ) , \qquad ( 5 )$$

It is made up by K parallel coding path, where the code rate of each path equals to 1/N, and the total code rate is K/N.

For the non-linear OVCDM (OVCDMA), we focus on the relationship of \tilde{v}ₙ^{T} and \tilde{v}ₙ.

\tilde{v}ₙ^{T}=F⁻¹(Vₙ^{T}),Vₙ=F(\tilde{v}ₙ), (6)

Others remain the same.

Like any other multiplexing (multiple address) technology, OVCDM (OVCDMA) also requires the one-to-one mapping relationship between the input and output sequences, namely, one output sequence can not correspond to two or more input sequences, and vice versa. For each parallel coding branch, because their code rates are all less than or equal to 1, it's obvious that there is one-to-one mapping relationship (unless choosing bad coding vector like all-zeros). When K≦N, as the total code rate is also less than or equal to 1, it's certain that there exists one-to-one relationship (unless choosing bad coding matrix like zero matrix or non-full rank matrix).

Then we will study in which condition there is one-to-one relationship between input and output sequence. If it does exist, we can use convolutional coding with code rate higher than 1 to increase the spectrum efficiency. Of course, if other types of coding with code rate higher than 1 also have one-to-one relationship, the corresponding coding can be used to increase the spectrum efficiency.

OVCDM system has 2^{QK(L-1)} stable states in binary representation, which respectively are:

$$\{ \underbrace{\begin{matrix}+ & + & … & +\end{matrix}}_{KQ ( L - 1 )} , \underbrace{\begin{matrix}+ & + & … & -\end{matrix}}_{KQ ( L - 1 )} , … , \underbrace{\begin{matrix}- & - & … & -\end{matrix}}_{KQ ( L - 1 )} \}$$

The initial state and final state are all-zero state, that is

$$\{ \underbrace{\begin{matrix}0 & 0 & … & 0\end{matrix}}_{KQ ( L - 1 )} \} ,$$

In binary representation, if the front (left) KQl (l=1,2, . . . , L−2) binary data is all zero, we call this state the anterior transition state; if the after (right) KQl (l=1,2, . . . , L−2) binary data is all zero, we call this state the posterior transition state. The initial state, anterior transition state and stable states can shift to other 2^{QK} anterior transition states or stable states, but stable states and posterior transition states can only be shifted from the anterior 2^{QK} stable states or posterior transition states, initial state and anterior states can shift only to the posterior states and the final state, and the posterior states can only be shifted from the anterior states. The states transition relation is shown as follows:

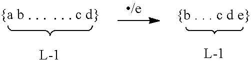

Where, a, b, . . . , c, d, e are all K-dimension vectors (QK-dimension binary vectors) including K-dimension zero vector (which is determined by it's anterior state or posterior state), e of

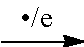

represents the new input K-dimensional vector, the oldest (foremost) K-dimensional vector leaves as a new input K-dimensional vector enters, of

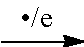

represents the corresponding output of branch coding (branch Metric).

If there still exists a one-to-one relationship between the input coding sequence and the output sequence when the code rate is higher than 1, we can use convolutional OVCDM (OVCDMA) to greatly increase the spectrum efficiency of system.

From the Example 1 and Example 2 of the existing technology, we can find out that it is impossible to construct a code with a one-to-one relationship between input and output data when the elements of coding matrix are in the same finite field in traditional coding structure with code rate higher than 1. But if the coding leaves the finite field and the set of codewords' polynomials {\tilde{v}ₖ(x)},k=0,1, . . . , K−1, is relatively prime (linear independent), the coding with code rate higher than 1 can be one-to-one relationship.

For this purpose, the encoder tap polynomials bₖ(x),k=0,1, . . . , K−1, must be coprime (linear independent).

For this purpose, we show an example as follows:

### Example 3

### K=3, N=1, L=3, Q=2

Parallel Input Data:

$${U}_{n} = [ \begin{matrix}{\tilde{u}}_{n , 0} \\ {\tilde{u}}_{n , 1} \\ {\tilde{u}}_{n , 2}\end{matrix} ] , {\tilde{u}}_{n , k} ∈ \{ + 1 , - 1 \} , k = 0 , 1 ,$$

Encoding Matrix:

$$B = [ \begin{matrix}1 & 1 & 1 \\ 1 & {e}^{j2π / 3} & {e}^{- j2π / 3} \\ 1 & {e}^{- j2π / 3} & {e}^{j2π / 3}\end{matrix} ] ; \qquad ( 7 )$$

Parallel Coding Structure:

$${B}_{0} = [ \begin{matrix}1 \\ 1 \\ 1\end{matrix} ] , {B}_{1} = [ \begin{matrix}1 \\ {e}^{j2π / 3} \\ {e}^{- j2π / 3}\end{matrix} ] , {B}_{2} = [ \begin{matrix}1 \\ {e}^{- j2π / 3} \\ {e}^{j2π / 3}\end{matrix} ] ; \qquad ( 8 )$$

Coding Output:

\tilde{v}ₙ^{T}=Uₙ^{T}B₀+Uₙ₋₁^{T}B₁+Uₙ₋₂^{T}B₂, (9)

Polynomials of Coding Tap Coefficients:

b₀(x)=1+x+x²,b₁(x)=1+e^{j2π/3}x+e^{-j2π/3}x²,

b₂(x)=1+e^{-j2π/3}x+e^{j2π/3}x² (10)

They are irreducible to each other, namely linear independent.

Obviously, if the input and output of the coding has a one-to-one relationship, the spectrum efficiency of coding output can increase 3 times as the spectrum efficiency of input data.

Because {ũₖ(x)} is a set of symmetric function, {\tilde{v}ₖ(x)} must be a set of symmetric function similarly, it is enough to study the half-sets of positive elements {}+ of their sets{}, and the other elements of sets{}must be the negative ones of the elements of {}+.

As the constraint length L=3 and the length of check data equals to 3, namely the frame length equals to 5, sets of input {ũ₀(x)},{ũ₁(x)}, {ũ₂(x)}, all have 8 elements, which are

{1+x+x²,1+x−x²,1−x+x²,1−x−x²,−1+x+x²,−1+x−x²,−1−x+x²,−1−x−x²}

According to the symmetry of the set, we focus on the positive elements, which are:

{1+x+x²,1+x−x²,1−x+x²,1−x−x²}⁺.

The corresponding sets of positive elements coding output have 4 positive elements respectively:

$$\begin{matrix}{\{ {\tilde{v}}_{0} ( x ) \}}^{+} = {\{ {\tilde{u}}_{0} ( x ) \}}^{+} {b}_{0} ( x ) \\ = {\{ {\tilde{v}}_{00} ( x ) , {\tilde{v}}_{01} ( x ) , {\tilde{v}}_{02} ( x ) , {\tilde{v}}_{03} ( x ) \}}^{+} , \\ {\{ {\tilde{v}}_{1} ( x ) \}}^{+} = {\{ {\tilde{u}}_{1} ( x ) \}}^{+} {b}_{1} ( x ) \\ = {\{ {\tilde{v}}_{10} ( x ) , {\tilde{v}}_{11} ( x ) , {\tilde{v}}_{12} ( x ) , {\tilde{v}}_{13} ( x ) \}}^{+} , \\ {\{ {\tilde{v}}_{2} ( x ) \}}^{+} = {\{ {\tilde{u}}_{2} ( x ) \}}^{+} {b}_{2} ( x ) \\ = {\{ {\tilde{v}}_{20} ( x ) , {\tilde{v}}_{21} ( x ) , {\tilde{v}}_{22} ( x ) , {\tilde{v}}_{23} ( x ) \}}^{+} ,\end{matrix}$$

$$Where , \\ {\tilde{v}}_{00} ( x ) = 1 + 2 x + 3 {x}^{2} + 2 {x}^{3} + {x}^{4} , {\tilde{v}}_{01} ( x ) = 1 + 2 x + {x}^{2} - {x}^{4} , \\ {\tilde{v}}_{02} ( x ) = 1 + {x}^{2} + {x}^{4} , {\tilde{v}}_{03} ( x ) = 1 - {x}^{2} - 2 {x}^{3} - {x}^{4} , \\ {\tilde{v}}_{10} ( x ) = 1 - {e}^{- j2π / 3} x - {x}^{3} + {e}^{- j2π / 3} {x}^{4} , \\ {\tilde{v}}_{11} ( x ) = 1 - {e}^{- j2π / 3} x - 2 {x}^{2} + ( {e}^{- j2π / 3} - {e}^{j2π / 3} ) {x}^{3} - {e}^{- j2π / 3} {x}^{4} = 1 - {e}^{- j2π / 3} x - 2 {x}^{2} - j \sqrt{3} {x}^{3} - {e}^{- j2π / 3} {x}^{4} , \\ {\tilde{v}}_{12} ( x ) = 1 + ( {e}^{j2π / 3} - 1 ) x + ( 1 + {e}^{- j2π / 3} - {e}^{j2π / 3} ) {x}^{2} + ( {e}^{j2π / 3} - {e}^{- j2π / 3} ) {x}^{3} + {e}^{- j2π / 3} {x}^{4} = 1 - ( 1 - {e}^{j2π / 3} ) x + ( 1 - j \sqrt{3} ) {x}^{2} + j \sqrt{3} {x}^{3} + {e}^{- j2π / 3} {x}^{4} , \\ {\tilde{v}}_{13} ( x ) = 1 - ( 1 - {e}^{j2π / 3} ) x - ( {e}^{j2π / 3} - {e}^{- j2π / 3} + 1 ) {x}^{2} + {x}^{3} - {e}^{- j2π / 3} {x}^{4} = 1 - ( 1 - {e}^{j2π / 3} ) x - ( 1 + j \sqrt{3} ) {x}^{2} + {x}^{3} - {e}^{- j2π / 3} {x}^{4} , \\ {\tilde{v}}_{20} ( x ) = 1 - {e}^{j2π / 3} x - {x}^{3} + {e}^{j2π / 3} {x}^{4} , \\ {\tilde{v}}_{21} ( x ) = 1 + ( 1 + {e}^{- j2π / 3} ) x - 2 {x}^{2} + ( {e}^{j2π / 3} - {e}^{- j2π / 3} ) {x}^{3} - {e}^{j2π / 3} {x}^{4} = 1 + ( 1 + {e}^{- j2π / 3} ) x - 2 {x}^{2} + j \sqrt{3} {x}^{3} - {e}^{j2π / 3} {x}^{4} , \\ {\tilde{v}}_{22} ( x ) = 1 - ( 1 - {e}^{- j2π} ) x + ( {e}^{j2π / 3} - {e}^{- j2π / 3} + 1 ) {x}^{2} + ( {e}^{- j2π / 3} - {e}^{j2π / 3} ) {x}^{3} + {e}^{j2π / 3} {x}^{4} = 1 - ( 1 - {e}^{- j2π / 3} ) x + ( 1 + j \sqrt{3} ) {x}^{2} - j \sqrt{3} {x}^{3} + {e}^{j2π / 3} {x}^{4} , \\ {\tilde{v}}_{23} ( x ) = 1 - ( 1 - {e}^{- j2π / 3} ) x + ( {e}^{j2π / 3} - {e}^{- j2π / 3} - 1 ) {x}^{2} - ( {e}^{j2π / 3} + {e}^{- j2π / 3} ) {x}^{3} - {e}^{j2π / 3} {x}^{4} = 1 - ( 1 - {e}^{- j2π / 3} ) x - ( 1 - j \sqrt{3} ) {x}^{2} + {x}^{3} - {e}^{j2π / 3} {x}^{4}$$

According to the symmetry, there are

\tilde{v}ₖ₄(x)=−\tilde{v}ₖ₃(x),\tilde{v}ₖ₅(x),=−\tilde{v}ₖ₂(x)\tilde{v}ₖ₆(x)=−\tilde{v}ₖ₁(x),\tilde{v}ₖ₇(x)=−\tilde{v}ₖ₀(x),∀=0,1,2,

Since there are not so many codewords, it's easy to check that there is no element that is equal, opposite to others, or equal to the sum (difference) of other two elements, namely linear elements, in these above positive semi-sets {\tilde{v}₀(x)}+, {\tilde{v}₁(x)}+, {\tilde{v}₂(x)}+, According to the symmetry of codewords, in the universal sets{\tilde{v}₀(x)}, {\tilde{v}₁(x)}, {\tilde{v}₂(x)}, there is no element that is equal, opposite to others, or equal to the sum (difference) of other two elements, namely linear elements. Thus there is no need to check 512 encoding output of this codeword. Otherwise, due to the constraint length being 3, there is no need to further check the condition of longer data length. Hence, we can conclude that the coding input-output relationship of Example 3 must be one-to-one relationship. Furthermore, if the input data is not binary but quaternary QPSK, namely ũ_{n,k}ε{+1,−1,+j,−j}, in polynomial and b₁(x),b₂(x) are irreducible, the input-output relationship is also one-to-one relationship. Thus, the coding method is an effective method which can increase 3 times the coding efficiency, not only for the binary data input, but also the quaternary data input.

Thus, if the coding is away from the finite field, the coding tap coefficients polynomials bₖ(x),k=0,1, . . . , K−1, are relatively prime (linear independent), and the input and output sequence of OVCDM (OVCDMA) must be one-to-one relationship with any code rate (including code rate larger than 1).

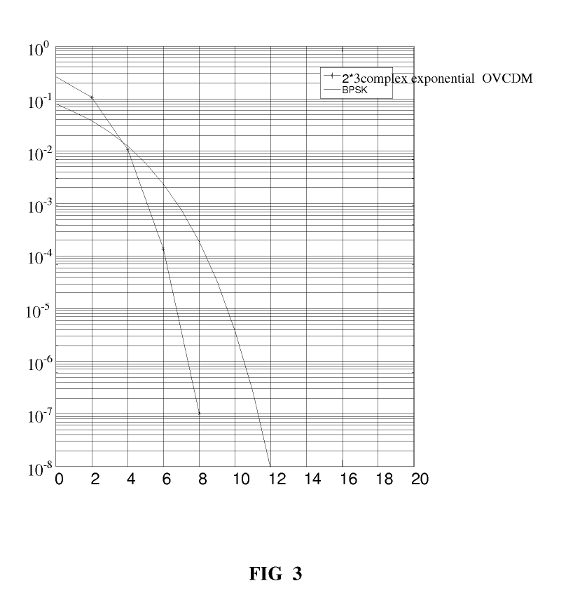

FIG. 3 shows a result of simulation. With

$${V}_{n}^{T} = exp \{ j [ {\sum }_{l = 0}^{Min ( n , L - 1 )} {U}_{n - l}^{T} {B}_{l} ] \} \qquad ( 12 )$$

non-linear coding, the output data is binary χ={0,1} by using dual OVCDM (OVCDMA) with constraint length of 3, and the coding parameters are: K=2,N=1,L=3. After complex exponential OVCDM(OVCDMA) processing, the system capacity and spectrum efficiency can increase 2 times.

Here:

$${U}_{n} = {[ {\tilde{u}}_{0 , n} , {\tilde{u}}_{1 , n} ]}^{T} , \\ {\tilde{u}}_{k , n} ∈ \{ 0 , 1 \} , k = 0 , 1 , \\ B = [ \begin{matrix}π & 0 & 0 \\ \frac{π}{2} & \frac{π}{4} & \frac{π}{2}\end{matrix} ] \qquad ( 13 )$$

The right curve represents the properties of BPSK and QPSK, the left shows the property of OVCDM, the abscissa represents SNR (unit dB), and the ordinate stands for BER.

FIG. 5 is the coding structure of FIG. 3.

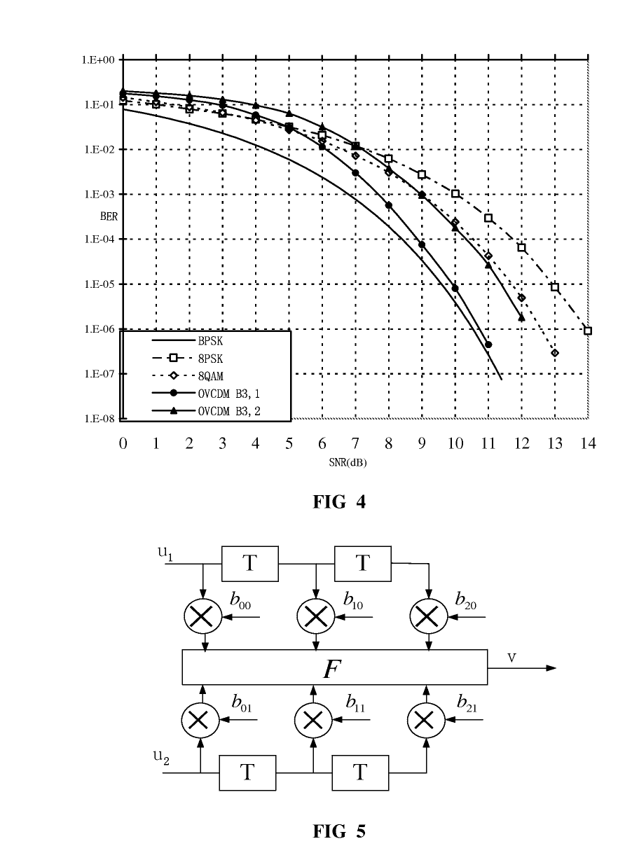

FIG. 4 is another result of simulation. With

$${\tilde{v}}_{n}^{T} = {\sum }_{l = 0}^{Min ( n , L - 1 )} {U}_{n - l}^{T} {B}_{l} , \qquad ( 14 )$$

non-linear coding, the output data is binary χ={+1,−1}, by using triple OVCDM(OVCDMA) with constraint length of 3, and the coding parameters are: K=3,N=1,L=3. After complex exponential OVCDM(OVCDMA) processing, the system capacity and spectrum efficiency can increase 3 times.

Where:

$${U}_{n} = {[ {\tilde{u}}_{0 , n} , {\tilde{u}}_{1 , n} , {\tilde{u}}_{2 , n} ]}^{T} , \\ {\tilde{u}}_{k , n} ∈ \{ + 1 , - 1 \} , k = 0 , 1 , 2 , \\ {B}_{3 , 1} [ \begin{matrix}1 & - j & - j \\ - j & j & - 1 \\ 1 & j & 1\end{matrix} ] , \\ {B}_{3 , 2} = [ \begin{matrix}1 & 1 & 1 \\ 1 & {e}^{j 2 π / 3} & {e}^{- j 2 π / 3} \\ 1 & {e}^{- j 2 π / 3} & {e}^{j 2 π / 3}\end{matrix} ] , \qquad ( 15 )$$

From FIG. 3 and FIG. 4 we can see that although we only use the simple 2×3 and 3×3 coding matrices with short constraint length (L=3), the advantage of the coding shows obviously, and spectrum efficiency is respectively 2 and 3 times of BPSK(Q=1). Besides, after double (FIG. 3) and three times the number of users, basically, their normalized threshold signal interference ratio (SIR) at low BER are not increased even if decreased over 3 dB (FIG. 3). But the system capacity and spectrum efficiency are increased by 2 and 3 times respectively. This proves that multi-signal source of multiplexing or multi-user of multiple access share the channel capacity. Obviously, for OVCDM (OVCDMA) with higher K especially with longer constraint length L, there must be the same conclusion after choosing optimal encoding matrix. Of course, as shown same in other channel coding, the performance after OVCDM (OVCDMA) is even worse than the uncoded situation at low SIR (high BER). The simulation of coding with larger constraint length L proves that, when K is certain, the coding gain of system gradually improves with L increasing.

Giving the basic parameters of OVCDM (OVCDMA) K, N, L, and input data Q, the spectrum efficiency and coding gain of the OVCDM (OVCDMA) is subject to the chosen encoding matrix B. According to the theory of convolutional coding, the optimal encoding matrix B should ensure that the code has the maximum free distance d_{free}, and the front coefficients of the generator polynomial remain as small as possible.

As well known, so far even the traditional convolutional coding theory can't give the analytic relationship between the encoding matrix and the free distance. OVCDM (OVCDMA) is a more generalized convolutional coding, and it's harder to find the analytic solution of the optimal encoding matrix. The optimal encoding matrix can be found by using computer orgodicity.

With the optimal encoding matrix searched by using computer orgodicity, we can find out that the search complexity depends on number of stable states 2^{QKN(L-1)}. Generally speaking, the amount of searching work with larger Q, K, N, L will be amazing. Actually, when the parameters of OVCDM (OVCDMA) Q, K, N, L are given, the state of system and state transition relation are definite with all kinds of closed loop paths determined. Computer search can be carried out mainly around the relationship between the minimum Euclidean distance of those closed loop paths and the encoding matrix B. In order to reduce the computational complexity, we can only search some shorter closed loop paths. In general, Euclidean distance of non-minimal paths will become bigger with the growth of shorter closed paths' Euclidean distance. The present invention will provide some search algorithms as follows:

We can construct high-order coding matrix by using low-order coding matrix. If B^{K}^{₁} and B^{K}^{₂} are two known low order encoding matrix (K₁, N, L₁) and (K₂, N, L₂) respectively, the high order encoding matrix (K₁K₂, N,L₁L₂) is generated by the following steps:

B^{K}^{₁}^{K}^{₂}=B^{K}₁ [symbol] B^{K}^{₂},

where [symbol] indicates the matrix direct product (Kronecker Product).

Reference: the optimal (K,1,1) order encoding matrix B^{K} is the column vector [1,2, . . . , 2^{K-1}]^{T}, when the input quaternionic data is χ={+1,−1,+j,−j} and L=1, N=1.

As another example, if B^{K}^{₁} and B^{K}^{₂} are two known low order encoding matrix (K₁, N, L₁) and (K₂, N, L₂) respectively, the high order encoding matrix (K₁+K₂,N,2 L₁+L₂−1) is generated by the following steps:

$${B}^{{K}_{1} + {K}_{2}} = [ \begin{matrix}{B}^{{K}_{1}} {0}_{1} & {0}_{2} \\ {0}_{3} & {B}^{{K}_{2}}\end{matrix} ] ,$$

where 0₁, 0₂, 0₃ are K₁×L₁−1,K₁×L₂,K₂×(2 L₁−1) order where all-zero matrix.

The necessary conditions of having one-to-one relationship between the coding input data and output sequence are: the coding is beyond the finite field, codeword polynomial sets {\tilde{v}ₖ(x)},k=0,1, . . . , K−1, must be relatively prime (linear independent), coding tap coefficient polynomials bₖ(x),k=0,1 . . . , K−1, must be relatively prime (linear independent), there is no more than one data polynomial in bₖ(x), and the others are non-data polynomial and relatively prime.

For example, in the parallel coding model of multiplexing (multiple access) technologies, coding tap coefficients may not in the same field, such as: TDM (TDMA), FDM (FDMA), SDM (SDMA), or linear unrelated, independent such as: TDM (TDMA), FDM (FDMA), OFDM (OFDMA), CDM (CDMA), statistical Space Division Multiplexing MIMO and so on. As another example, in the parallel coding model of multi-level (high-dimension) modulation signals such as PAM, PM, QAM etc, there is one data polynomial for coding tap coefficients, and the others are all non-data polynomial and relatively prime.

It's the simplest way to make the encoding tap coefficients relatively prime by putting them in different fields or in the same but rotated or overlapped field in OVCDM (OVCDMA) system. For example, put the encoder taps in different fields or in time domain, space domain, frequency domain, mixed domain, allowing them have great overlapping. In this way, we actually find a better way to realize OVTDM, OVSDM, OVFDM and OVHDM by coding method.

With more system simulation, it can be fully proved that the general convolutional OVCDM (OVCDMA) is a new transmission technology with a high performance far better than any existing technology.

Detailed steps of the present invention are as follows:

Step 1: according to the type of practical system (multiplexing system or multiple address system) and the specific requirement of spectrum efficiency,

1) Confirm the Format of the Input Data

such as binary data Q=1): χ={+1,−1} or χ={0, 1}; quaternary data (Q=2): χ={+1, −1,+j,−j}, or χ={00, 01 ,10, 11} etc. Here, Q presents the information bits each input symbol carries.

2) Select the basic parameters of the linear or non-linear code multiplexing (access): K, N and L.

where, K denotes the branch number of parallel coding, N denotes the number of output coded symbols corresponding to each input encoding symbols, L is the constraint length of the coding, K is the most important parameter, as it represents the number of basic parallel sub-channels that share the same channel capacity, and KQ/N indicates the number of information bits loaded by each coding symbol. When it is an orthogonal multi-carrier system, KQ/N is equivalent to the potential gross spectral efficiency (bps/Hz) of the system. KLQ indicates the complexity index of the system for decoding detection. The bigger KLQ is, the more complicated the decoding detection is, and the decoding detection delay is longer, but the transmission reliability (anti-interference) of the system is better, and the threshold of SNR is also lower. Choosing these parameters should consider actual need and repeated deliberation.

Step 2: In accordance with the specific indicators of the actual system requirements, determine the “domain” of the value of encoding matrix B as well as the constraints.

1) Determine the “field” (that is, the value space) of the encoding matrix B:

For example: the elements of the encoding matrix B can locate in different or rotated or overlapped code domain. For a multi-antenna system, the elements of B can locate in different or rotated or overlapped space domain, and special attention should be paid to the relative amplitude and phase of different elements from the same line or column of encoding matrix B instead of elements from different lines or columns. For a non-orthogonal multi-carrier system, the elements of matrix B can locate in different or rotated or overlapped frequency domain, and special attention should be paid to the relative amplitude and phase of the different elements from the same line or column of matrix B instead of elements from different lines or columns.

2) Determine the range of the encoding matrix B:

As it is not possible and realistic to search the optimal encoding matrix from the infinite space, it is necessary to limit the range of elements of B after determine the “field” (that is, the value space) of the encoding matrix. More specifically, no matter in theory or in practice, there often should be some constraints on the values of B, such as in theory, its values are samples of the Gaussian (normal) distribution random variables, or samples of uniformly distributed random variable on a range of a complex plane, or values that are limited in some particular interval. While, in practice, the range often has close relation to the most significant amplitude resolution, the phase resolution, the spatial resolution, the frequency resolution, the time resolution of the system, as well as the non-linear distortion, the peak power and peak-to-average ratio (PAR) allowed by the system. These parameters constitute the constraints for the range of the elements of matrix B, and it needs repeated deliberation and calibration to determine the range as some of the constraints are indirect obtained.

The actual value of elements in matrix B can be:

\textcircled{1} {a+jb},a,bε{0,±1,±2, . . . } or other limited non-integer real number;

\textcircled{2} on the unit circle, or in the circle;

\textcircled{3} on or above the real axis or imaginary axis;

\textcircled{4} in a range of the complex or real plane;

\textcircled{5} the sample of certain complex or real Gaussian (normal) distribution random variables;

According to the classic Shannon information theory, channel capacity C is the maximum value (discrete channel) or supremum (continuous channel) of mutual information between the input and output sequence of the channel. For additive white Gaussian noise (AWGN) channel (continuous channel):

$$C {sup}_{Q ( x )} I ( X ; Y )$$

where, Q(x) is the priori probability of the channel input X.

For additive white Gaussian noise (AWGN) channel, there are some conclusions in the information theory: when the noise is Gaussian (normal) distribution, the channel input should also be Gaussian (normal) distribution, and the channel capacity C can be achieved only when they have the same variance.

For the traditional modulation schemes, such as BPSK, its channel input is binomial distributed; QPSK signals are four-phase distributed; Multi-PSK, QAM signals are subject to polynomial distribution by nature. Therefore, there are certain gaps with channel capacity, as the channel input X is not subject to the optimal distribution for the traditional modulation under additive white Gaussian noise (AWGN) channel.

For the BPSK input signal of OVFDM (OVFDMA) and OVTDM (OVTDMA) system which is a special case of the overlapped code division multiplexing (multiple access) OVCDM (OVCDMA), the two-level BPSK signal becomes K+1 level after K overlapping. The greater K is, the more levels are. Similarly, when the input signal is QPSK, the overlapped in-phase channel I and quadrature Q channel become multi-level. According to the central limit theorem, when the K is greater, the levels are more, and the distribution of the input signal tends to be complex or real Gaussian (normal), which is the real reason that the OVTDM (OVTDMA), OVFDM (OVFDMA) system mentioned here presents better performance than QAM with the same spectral efficiency.

The overlapped code division multiplexing (multiple access) OVCDM (OVCDMA) system processes the input symbols by multiplying a complex weighted value, then overlapping the symbols. Through the procedure, the statistic characteristics of the channel input information can be partially changed. If each tap is a Gaussian (normal) distributed random variable, the linear combination of random variables are still Gaussian (normal) distributed after the procedure. Thus, it is a Gaussian (normal) variable for the channel input, which may reach the channel capacity. For the system design and system simulation, the coding tap coefficient being complex or real Gaussian (normal) random variables is hard to achieve, but the samples of the complex or real Gaussian (normal) random variables can be used as coding tap coefficients.

\textcircled{6} the samples of uniformly distributed random variables in a certain interval in the complex or real plane;

Since Gallager has proven the performance of linear block codes by the use of random coding and Gallager bound. Although there is some possibility that the same codeword corresponds to multiple information sequence, and the smallest Hamming distance among the multiple information sequences is zero, it does not affect the final result that BER is decaying exponential on the premise of the coding rate which is less than the channel capacity. As there is surely some coding sequences which have bigger Hamming distance among different information sequence, if the good and bad coding sequences are uniformly distributed in the GF(Q^{N}), an expansion of the dual domain, the statistical average results tend to be good. This may lie in that there are more good coding sequences than bad ones in the entire complex plane, which reminds us that there may be more good coding tap coefficients than bad ones in the complex plane. Of course, we can not search them within the entire complex plane, but we can quickly find some good coding tap coefficients in certain given interval of the complex plane.

Step 3: According to the constraints mentioned in Step 2, search the optimal encoding matrix B:

The first suggested search algorithm of the optimal encoding matrix B:

Principle: the search range of the optimal encoding matrix B can only focus on a number of short closed paths which has been pointed out in the previous section of the invention. Suppose the correct path and error path, respectively

U=U₀,U₁, . . . , Uₙ, . . . , [symbol] U′=U′₁, . . . , U′ₙ, . . . , n=0,1,2, . . .

Where, Uₙ=[ũ_{n,0} ũ_{n,1} . . . ũ_{n,K-1}]_{T} are K parallel transmission data symbol vectors in the nth symbol denotes error tε[nT,(n+1)T, n=0,1,2, . . . , Xₙ Uₙ−Uₙ denotes error symbol vectors during the interval. Suppose B=[B₀,B₁,B₂, . . . , B_{L-1}] is the encoding matrix, and the node error event starts from tε[nT,(n+1)T), that is the nth node in the Trellis diagram. Then, there should be Xₙ≠1), namely there is only one error symbol vector(Xₙ≠0) in the shortest node error event, whose path length is L, and its type is

$$… , 0 , {X}_{n} , \underbrace{0 , 0 , … 0}_{L - 1} \\ ↑ node error event starts from here \\ ↑ error ends here$$

The branch metric with length L, which is caused by the node error event, is Xₙ^{T}B=Xₙ^{T}B₀,Xₙ^{T}B₁, . . . , Xₙ^{T}B_{L-1} in sequential order. The square of Euclidean distance between error path of this type and the correct path is as follows:

$$\begin{matrix}{d}^{2} ( {X}_{n} ) = {‖ {X}_{n}^{T} B ‖}^{2} \\ = {X}_{n}^{T} {BB}^{H} {X}^{*} \\ = {X}_{n}^{T} {B}_{0} {B}_{0}^{H} {X}_{n}^{*} + {X}_{1}^{T} {B}_{1} {B}_{1}^{H} {X}_{n}^{*} + … + \\ {X}_{n}^{T} {B}_{L - 1} {B}_{L - 1}^{H} {X}_{n}^{*} \\ = {‖ {X}_{n}^{T} {B}_{0} ‖}^{2} + {‖ {X}_{n}^{T} {B}_{1} ‖}^{2} + … + {‖ {X}_{n}^{T} {B}_{L - 1} ‖}^{2} ,\end{matrix}$$

There are L−2 path lengths which contain 2 symbol error vectors in the node error event whose lengths are L+1, L+2, . . . , 2 L−1 respectively, where, the type of node error event whose length is L+1 is:

$$… , 0 , {X}_{n} , {X}_{n + 1} , \underbrace{0 , 0 , … 0}_{L - 1} \\ ↑ node error event starts from here \\ ↑ error ends here$$

The branch metric with length L+1,which is caused by the node error event, is Xₙ^{T}B+Xₙ₊₁^{T}B=Xₙ^{T}B₀,Xₙ^{T}B₁+Xₙ₊₁^{T}B₀,Xₙ^{T}B₂+Xₙ₊₁^{T}B₁, . . . , Xₙ^{T}B_{L-1}+Xₙ₊₁^{T}B_{L-1} in sequential order, where Xₙ₊₁ lags one sign bit than Xₙ. The square of Euclidean distance between error path and correct path is as follows:

$$\begin{matrix}{d}^{2} ( {X}_{n} , {X}_{n + 1} ) = {‖ {X}_{n}^{T} B + {X}_{n + 1}^{T} B ‖}^{2} \\ = {[ {X}_{n}^{T} B + {X}_{n + 1}^{T} B ] [ {X}_{n}^{T} B + {X}_{n + 1}^{T} B ]}^{H} \\ = {‖ {X}_{n}^{T} {B}_{0} ‖}^{2} + {‖ {X}_{n}^{T} {B}_{1} + {X}_{n + 1}^{T} {B}_{0} ‖}^{2} + … + \\ {‖ {X}_{n}^{T} {B}_{L - 1} + {X}_{n + 1}^{T} {B}_{L - 2} ‖}^{2} + {‖ {X}_{n + 1}^{T} {B}_{L - 1} ‖}^{2} ,\end{matrix}$$

The type of node error event whose length is L+2 is:

$$… , 0 , {X}_{n} , 0 , {X}_{n + 2} , \underbrace{0 , 0 , … 0}_{L - 1} \\ ↑ node error event starts from here \\ ↑ error ends here$$

The branch metric with length L+2, which is caused by the node error event, is Xₙ^{T}B+Xₙ₊₂^{T}B=Xₙ^{T}B₀,Xₙ^{T}B₁,Xₙ^{T}B₂+Xₙ₊₂^{T}B₀, . . . , Xₙ^{T}B_{L-1}+Xₙ₊₂^{T}B_{L-3},Xₙ₊₂^{T}B_{L-2},Xₙ₊₂^{T}B_{L-1}, in sequential order, where Xₙ₊₂ lags two sign bits than Xₙ. The square of Euclidean distance between error path and correct path is as follows:

$$\begin{matrix}{d}^{2} ( {X}_{n} , {X}_{n + 2} ) = {‖ {X}_{n}^{T} B + {X}_{n + 2}^{T} B ‖}^{2} \\ = {[ {X}_{n}^{T} B + {X}_{n + 2}^{T} B ] [ {X}_{n}^{T} B + {X}_{n + 2}^{T} B ]}^{H} \\ = {‖ {X}_{n}^{T} {B}_{0} ‖}^{2} + {‖ {X}_{n}^{T} {B}_{1} ‖}^{2} + {‖ {X}_{n}^{T} {B}_{2} + {X}_{n + 2}^{T} {B}_{0} ‖}^{2} + … + \\ {‖ {X}_{n}^{T} {B}_{L - 1} + {X}_{n + 2}^{T} {B}_{L - 3} ‖}^{2} + {‖ {X}_{n + 2}^{T} {B}_{L - 2} ‖}^{2} + \\ {‖ {X}_{n + 2}^{T} {B}_{L - 1} ‖}^{2} ,\end{matrix}$$

The type of node error event with length 2 L−1 is:

$$… , 0 , {X}_{n} , \underbrace{0 , 0 , … , 0 ,}_{L - 2} {X}_{n + L - 1} , \underbrace{0 , 0 , … 0}_{L - 1} \\ ↑ node error event starts from here \\ ↑ error ends here$$

The branch metric with length 2 L−1, which is caused by the node error event, is Xₙ^{T}B+X_{n+L-1}^{T}B=Xₙ^{T}B₀,Xₙ^{T}B₁,Xₙ^{T}B₂, . . . , Xₙ^{T}B_{L-2},Xₙ^{T}B_{L-1}+X_{n+L-1}^{T}B₀,X_{n+L-1}B₁, . . . , X_{n+L-1}B_{L-1} in sequential order, where X_{n+L-1} lags L−1 sign bits than Xₙ. The square of Euclidean distance between error path and correct path is as follows:

$$\begin{matrix}{d}^{2} ( {X}_{n} , {X}_{n + L - 1} ) = {‖ {X}_{n}^{T} B + {X}_{n + L - 1}^{T} B ‖}^{2} \\ = {[ {X}_{n}^{T} B + {X}_{n + L - 1}^{T} B ] [ {X}_{n}^{T} B + {X}_{n + L - 1}^{T} B ]}^{H} \\ = {‖ {X}_{n + L}^{T} {B}_{0} ‖}^{2} + {‖ {X}_{n + L}^{T} {B}_{1} ‖}^{2} + … + \\ {‖ {X}_{n + L}^{T} {B}_{L - 1} + {X}_{n}^{T} {B}_{0} ‖}^{2} + {‖ {X}_{n}^{T} {B}_{1} ‖}^{2} + … + \\ {‖ {X}_{n}^{T} {B}_{L - 1} ‖}^{2} ,\end{matrix}$$

Similarly, the general form of the branch metric caused by the node error event, which contains 1≧2 error symbol vectors, is

[Xₙ+Xₙ₊ₖ_{₁}+Xₙ₊ₖ_{₁}₊ₖ_{₂}+ . . . +Xₙ₊ₖ_{₁}_{+ . . . +k}_{_{l−1}}]^{T}B,

l≧2,k₁,k₂, . . . , k₁₋₁ε{1,2, . . . , L−2} in sequential order,

The interval of the error vectors can arbitrarily change from 0 to L−2, and can not be greater than L−2. Otherwise, the node error event ends. The more the error vectors contained in the node error event are, the smaller the probability is. The optimal encoding matrix B=[B₀B₁ . . . B_{L-1}] should ensure that the minimum Euclidean distance between error path and correct path is the biggest. In other words, the free distance d_{free} is largest among various closed paths in the Trellis diagram, where d_{free} is defined as:

$${d}_{free} { Max}_{B} { Min}_{∀ {X}_{n} , {X}_{n + {k}_{1}} , … , {X}_{n + {k}_{1} + … + {k}_{l - 1}} ∈ χ , ∀ B , ∀ l \geq 1} ‖ [ {X}_{n} + {X}_{n + {k}_{1}} + {X}_{n + {k}_{1} + {k}_{2}} + … + {X}_{n + {k}_{1} + … + {k}_{l - 1}} ] B ‖ ,$$

where, Xₙ≠0,Xₙ₊ₖ_{₁}≠0,Xₙ₊ₖ_{₁}≠0, . . . Xₙ₊ₖ_{₁}₊ₖ_{₂}_{+ . . . +k}_{_{l−1}}≠0,

k₀₌0,l≧1, k₁,k₂, . . . , k₁₋₁ε{1,2, . . . , L−2}

Generally speaking, the probability of the shorter node error event is bigger, thus it's enough to search the optimal encoding matrix by adding some shorter node error events to the shortest one.

The corresponding suggested search algorithm:

Sub-step 1: According to the closed distance characteristic of the linear codes, we can arbitrarily choose a correct path. It is assumed that the node error starts from the nth node, then we search from the shortest closed path of the first error symbol, and find the optimal encoding matrix B for all possible error symbols ∀Xₙ (a total of (2^{QK}−1)) under the constraints of Step 2, which satisfies

$${d}_{free}^{1} {Max}_{B} {Min}_{∀ {X}_{n} ∈ {χ}^{K} , ∀ B} ‖ {X}_{n}^{T} B ‖ ,$$

and then list the optional encoding matrix B₁,B₂,B₃, . . . according to the descending order of d_{free}¹ for the later use;

Sub-step 2: calculate the following formula with B₁,the first optimally selected encoding matrix which is selected by Sub-step 1, wherein the closed loop path contains two symbol errors, and the formula is:

$${d}_{free}^{2} {Min}_{{X}_{n} , {X}_{n + {k}_{1}} ∈ {χ}^{K} , ∀ {k}_{1}} ‖ {[ {X}_{n} + {X}_{n + {k}_{1}} ]}^{T} {B}_{1} ‖ , \\ {k}_{1} ∈ \{ 1 , 2 , … , L - 2 \} ,$$

If d_{free}²≧d_{free}¹, Sub-step 2 end, and step into Sub-step 3; otherwise, calculate the above formula with B₂, the second optimally selected encoding matrix which is selected by Sub-step 1; if d_{free}²≧d_{free}¹ cannot meet, calculate the above formula with B³, the third optimally selected encoding matrix which is selected by Sub-step 1; repeat the procedure until d_{free}²≧d_{free}¹, then step into Sub-step 3;

Sub-step 3: calculate the following formula with B, the optimal encoding matrix which is selected by Sub-step 1 and Sub-step 2, wherein the closed loop path contains three symbol errors, and the formula is:

$${d}_{free}^{3} {Min}_{{X}_{n} , {X}_{n + {k}_{1}} , {X}_{n + {k}_{1} + {k}_{2}} ∈ {χ}^{K} , ∀ {k}_{1} , {k}_{2}} ‖ {[ {X}_{n} + {X}_{n + {k}_{1}} + {X}_{n + {k}_{1} + {k}_{2}} ]}^{T} B ‖ , {k}_{1} , {k}_{2} ∈ \{ 1 , 2 , … , L - 2 \} ,$$

If d_{free}³≧d_{free}²≧d_{free}¹, Sub-step 3 end; otherwise, calculate the formula in Sub-step 2 with B, the second optimally selected encoding matrix which is selected by Sub-step 1; if d_{free}³≧d_{free}²≧d_{free}¹, cannot meet, calculate the formula in Sub-step 2 with B, the next optimally selected encoding matrix; repeat the procedure until d_{free}³≧d_{free}²≧d_{free}¹, search in the closed loop path which contains four symbol errors . . . ; repeat the procedure until the encoding matrix B remains basically unchanged, when the number of symbol errors of the closed loop path keeps growing.

Some description for the search algorithm:

(1) In theory, especially from the sense of the average collection: except the catastrophic code, the Euclidean distance the of the closed path that contains more errors is generally bigger than the closed path which contains less errors. But the catastrophic code can not be used. Thus, if the catastrophic code is not the initial choice, there will be only a small number of search steps before it concludes. As we all know, the expanded form of the generating function of general convolutional code is mostly the monic polynomial, which means that its free distance is often the shortest path and the only one. Another discovery is that: among some convolutional codes such as the Trellis code in particular, the shortest path distance of the closed path does not necessarily the free distance sometimes, but we can always find the free distance in some closed path with relatively short path. That is why we propose to start from the shortest path and search some longer closed path as well.

(2) The largest free distance does not necessarily guarantee the optimal performance of the error probability of the system, we must also consider the distribution of the different path distance, meaning that, we should compare the coefficients of the expanded form of the generating function, especially the front coefficient of the expanded form. When the free distance is the same, the smaller the front coefficients are, the better performance the system is. Since the generating function is not easy (not impossible) to demonstrate directly in the procedure of searching the largest free distance, and it's hard to get the generating function directly when K, N, L are large, it depends on the ultimate performance of the simulation to determine the optimal encoding matrix among the matrix with similar free distance.

(3) The smaller constraint length LN can make the decoding complexity decrease significantly, but it will lead to the reduced coding gain. We should take various factors into account in designing the search algorithm.

Another search algorithm in searching the K×NL order matrix B:

Inspired by the coding rules of QAM signal, as well as the Trellis code, we put forward a selected criteria for a second optimal encoding tap coefficient, and propose a corresponding search algorithm. Firstly, we provide a definition:

Defining: before K′(K′≦K) the Euclidean modulus of all the branches in the lth (l=0,1, . . . , L−1) node of the code division multiplexing system is defined as a collection

$${\{ {d}_{1} \}}_{{K}^{′}} \{ {[ {‖ {\sum }_{{k}^{′} = 0}^{{K}^{′} - 1} {\sum }_{{l}^{′} = 0}^{l} {\tilde{u}}_{{n}_{0 - {l}^{′} , {k}^{′}}} {b}_{{k}^{′} , {l}^{′}}^{T} ‖}^{2} ]}^{1 / 2} \}$$

$$∀ {n}_{0} > l , ∀ {\tilde{u}}_{n , {k}^{′}} ∈ χ , {k}^{′} = 0 , 1 , … , {K}^{′} - 1 , 1 ≦ {K}^{′} ≦ K , l = 0 , 1 , … . L - 1 ,$$

That is, ũ_{n,k′} must take over the elements of data collection χ.

$${[ D \}}^{{K}^{′} } {\sum }_{l = 0}^{L - 1} ( {\{ {d}_{l} \}}_{{K}^{′}} - {\{ {d}_{l} \}}_{{K}^{′} - 1} ) \neq Ø , ∀ {K}^{′} ≦ K - 1 ,$$

Obviously, there must be

That is, for any K′≦K, the difference between the total collection {D}^{K′} is not empty set Ø, then the relationship between input and output encoding symbols must be one-to-one diagramming, and obviously the bigger the number of the node l, the greater the difference, which will cause greater difference between all the bₖ(x), and greater Euclidean distance between the codewords.

The corresponding search algorithm:

Assuming the encoding matrix to be established is

$$B = [ \begin{matrix}{b}_{0}^{T} \\ {b}_{1}^{T} \\ ⋮ \\ {b}_{K - 1}^{T}\end{matrix} ] ,$$

where bₖ^{T}=[b_{k,0}^{T},b_{k,1}^{T}, . . . , b_{k,L-1}^{T}], b_{k,l}^{T}=[b_{k,0}^{l} b_{k,1}^{l} . . . b_{k,N-1}^{l}],

k=0,1, . . . , K−1, l=0,1, . . . , L−1,

Sub-step 1: arbitrarily select a b₀^{T}, and calculate its all {dₗ}₀, l=0,1, . . . L−1;

Sub-step 2: search the optimal b₁^{T} so that {D}¹≠Ø,

Constraint condition: b₁^{T}b₁*, namely, the squared Euclidean modulus of b₁^{T} is as small as possible, and there are as many as possible node l to make sure {dₗ}₁−{d_{l}}₀≠Ø, besides, assure that the node l differ greatly;

Sub-step 3: search the optimal b₂^{T} so that {D}²≠Ø,

Constraint condition: b₂^{T}b₂*, namely, the squared Euclidean modulus of b₂^{T} is as small as possible, and there are as many as possible node l to make sure {dₗ}₂−{dₗ}₁≠Ø, besides, assure that the node l differ greatly;

. . . ;

continue the above steps, until:

Sub-step K: search the optimal b_{K-1}^{T} so that {D}^{K-1}≠Ø,

Constraint condition: b_{K-1}^{T}b_{K-1}* namely, the squared Euclidean modulus of b_{K-1}^{T} is as small as possible, and there are as many as possible node l to make sure {dₗ}_{K-1}−{dₗ}_{K-2}≠Ø, besides, assure that the node l differs greatly.

Sub-step K+1: change the initial b₀^{T} and repeat Step 1 to Step K.

End.

Some description for the second search algorithm:

(1) The above steps only search the modules value of bₖ^{T}, the specific bₖ^{T}, k=0,1, . . . , K−1 still needs further judgment or simulation.

(2) The reason to make bₖ^{H}bₖ, namely, the squared Euclidean modulus of bₖ^{T} (k=0,1, . . . , K−1) is as small as possible, is that we hope the coded signals have the smallest average power.

(3) The biggest advantage of the algorithm is that we can easily increase its number of rows K and improve the spectrum efficiency based on the known optimal encoding matrix. Or, in the practical system, for the largest K selected already, we can adaptively increase or decrease the channel number of the parallel transmission within K in accordance with the conditions of channel.

(4) Although the smaller constraint length LN may cause the decoding complexity to decrease, but it will increase the average signal power and reduce the coding gain.

Step 4: constructing the high order encoding matrix from the low order encoding matrix:

As it's a hard work to search the high order encoding matrix, we can

Method 1: if B^{K}^{₁} and B^{K}^{₂} are two known low order encoding matrix (K₁, N, L₁) and (K₂, N, L₂) respectively, the high order encoding matrix (K₁K₂, N, L₁L₂) is generated by the following steps:

B^{K}^{₁}^{K}^{₂}=B^{K} [symbol] B^{K}^{₂},

where [symbol] indicates the matrix direct product (Kronecker Product).

Reference: the optimal (K,1,1) order encoding matrix B^{K} is the column vector [1,2, . . . , 2^{K-1}]^{T}, when the input quaternionic data is χ={+,−,j, j̅} and L=1, N=1.

Method 2: if B^{K}^{₁} and B^{K}^{₂} are two known low order encoding matrix (K₁, N, L₁) and (K₂, N, L₂) respectively, the high order encoding matrix (K₁+K₂,N, 2 L₁+L₂−1) is generated by the following steps:

$${B}^{{K}_{1} + {K}_{2}} = [ \begin{matrix}{B}^{{K}_{1}} {0}_{1} & {0}_{2} \\ {0}_{3} & {B}^{{K}_{2}}\end{matrix} ] ,$$

where 0₁,0₂,0₃ are K₁+L₁−1, K₁×L₂, K₂×(2 L₁−1) order all-zero matrix.

Step 5: Generate multiple signature sequences which the “wave division multiple access” system

Since the order of the optimal encoding matrix B searched by the optimal search algorithm is not large enough, and when the K, L is too much big, it will be a difficult job for decoding from the engineering perspective. While the access communications need multiple signature sequences, we can generate them by using the known optimal encoding matrix B as the “root” of the spanning tree by the following steps:

[B,B, . . . , B,0] [symbol] H₂ [symbol] H₄ [symbol] . . . [symbol] H₂_{ⁿ},

where H₂_{ⁿ}, n=0,1,2, . . . is any orthogonal expansion matrix such as Hadmard orthogonal matrix; 0 is K×L−1 order zero matrix; [symbol] indicates the direct product.

As it needs to insert an all-zero matrix in the “root” [B,B, . . . , B,0] (the actual system can be used as “pilot” signal), the length of B sequence should choose a longer one based on the actual channel condition. Obviously, the multiple signature sequences generated here is the orthogonal address code similarly with the traditional CDMA, which can only participate in the distribution and can not share channel capacity with other address.

In the practical system, Step 4 and Step 5 steps do not actually need to be implemented. We can choose one of them or neither of them to operate in accordance with the specific requirements.

Step 6: Form the multiple signature sequences by the searched or constructed encoding matrix, and design the multiplexing/access communication system transmitter with high spectral efficiency in accordance with the selected multiple signature sequences.

Step 7: According to the transmitter designed by Step 6, design the multiplexing/access communication system receiver with high spectrum efficiency.

Step 8: In the receiver, get the state diagram or tree diagram or Trellis diagram of the system in accordance with the status of the selected encoding matrix and state transition relations of the system, and detect the received signal with maximum likelihood or maximum a posteriori probability or other rapid sequential decoding detection algorithm, and detect the shortest Euclidean distance path with the received signal in the state diagram or tree diagram or Trellis diagram of the system.

The specific detection algorithm can refer to other previous patents of the present inventor, such as: PCT/CN2006/001585, PCT/CN2006/002012.

The transmission method of code division multiplexing and multiple access of the present invention is not meant to be limited to the aforementioned prototype system, and the subsequent specific description utilization and explanation of certain characteristics previously recited as being characteristics of this prototype system are not intended to be limited to such technologies.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. A code multiplexing transmission method by parallel linear or non-linear code with coding rate more than one is utilized for the multiplexing transmission.

2. A method as recited in claim 1 wherein said parallel code input bits sequence and output bits sequence have one-to-one relationship when said coding rate of said parallel code is more than one.

3. A method as recited in claim 2 wherein said method of said parallel coding is beyond the finite field, and all the parallel coding polynomial set {\tilde{v}ₖ(x)},k=0,1, . . . , K−1, is coprime with each other.

4. A method as recited in claim 2 wherein the tap polynomials of said parallel codes are coprime with each other.

5. A method as recited in claim 1 wherein said parallel codes include the generalized/narrowed linear or non-linear parallel convolutional code whose coding rate is more than one, or any generalized/narrowed linear or non-linear parallel code besides the convolutional code whose coding rate is more than one.

6. A method as recited in claim 5 wherein said method further comprising:
a) Said tap coefficient of said parallel coding being the sample value of complex or real Gaussian distribution random variables,
b) Said sample value of uniformly distributed random variables within a range of the complex or real plane or {a+jb},a,bε{0,±1,±2, . . . } or other limited non-integer real number, or
c) Said tap coefficient also locating at unit circle or on or above the real axis or imaginary axis.

7. A method as recited in claim 6 wherein said coding tap coefficient belong to different or rotated or overlapped domains, said domains comprising:
different or rotated or overlapped coding domains, different or rotated or overlapped spatial domains, different or rotated or overlapped frequency domains, different or rotated or overlapped time domains or the mixture of the above said domains.

8. A method as recited in claim 6 wherein said coding tap of the parallel coding polynomial with coprime coefficient should ensure that the codeword has the largest free distance.

9. A method as recited in claim 5 wherein said methods comprising:
a) Compositing the encoding matrix B containing K coding vectors,
b) Forming K parallel data transmission paths corresponding to the K coding vectors,
c) Processing the convolutional coding between each data path and the corresponding coding vector with the coding constraint length L,
d) Forming the N-dimensional output vectors by totaling the result of the K convolutional coding data paths,
e) Receiving said N-dimensional coding output vectors and take the sequence detection, and
f) Said K, N, L representing the basic parameters for said parallel coding.

10. A method as recited in claim 9 wherein after establishing said basic parameters K, N, L, the constraints in searching said encoding matrix B with the largest free Euclidean distance become that the elements of said encoding matrix B belong to different or rotated or overlapped code domains, space domains or frequency domains.

11. A method as recited in claim 10 wherein compositing said encoding matrix B comprising:
a) Determining the Trellis diagram of the code in accordance with the constraints and the basic parameters of said parallel coding,
b) Determining the closed loop path in accordance with said Trellis diagram of the code, and
c) Selecting said encoding matrix B with the largest free distance among said closed loop path.

12. A method as recited in claim 11 wherein selecting said encoding matrix B with the largest free distance among said closed loop path further comprising:
a) Step 1: starting searching from the shortest closed loop path with a vector symbol error, and finding the optimal encoding matrix B among all possible error symbols ∀Xₙ (total species (2^{QK}−1)) under the provisions of the constraints meeting the following formula:
$${d}_{free}^{1} {Max}_{B} {Min}_{∀ {X}_{n} ∈ {χ}^{K} , ∀ B} ‖ {X}_{n}^{T} B ‖$$
and listing the optional encoding matrix B₁,B₂,B₃, . . . according to the descending order of d_{free}¹,
b) Step 2: calculating the following formula with B₁ which is the first optimally selected encoding matrix and the closed loop path containing two symbol errors with the formula:
$${d}_{free}^{2} {Min}_{{X}_{n} , {X}_{n + {k}_{1}} ∈ {χ}^{K} , ∀ {k}_{1}} ‖ {[ {X}_{n} + {X}_{n + {k}_{1}} ]}^{T} {B}_{1} ‖ ,$$
k₁ε{1,2, . . . , L−2}, and ending Step 2 and stepping into Step 3 if d_{free}²≧d_{free}¹, otherwise calculating said formula with B₂ which is the second optimally selected encoding matrix selected by Step 1 and continuously calculating the above formula with B₃ if d_{free}²≧d_{free}¹ not satisfying, and repeating the procedure until d_{free}²≧d_{free}¹, before stepping into Step 3,
c) Step 3: calculating the following formula with B which is the optimal encoding matrix selected by Step 1 and Step 2 where the closed loop path contains three symbol errors with the formula:
$${d}_{free}^{3} {Min}_{{X}_{n} , {X}_{n + {k}_{1}} , {X}_{n + {k}_{1} + {k}_{2}} ∈ {χ}^{K} , ∀ {k}_{1} , {k}_{2}} ‖ {[ {X}_{n} + {X}_{n + {k}_{1}} + {X}_{n - {k}_{1} + {k}_{2}} ]}^{T} B ‖ ,$$
k₁,k₂ε{1,2, . . . , L−2}, and ending Step 3 if d_{free}³≧d_{free}²≧d_{free}¹, otherwise calculating the formula in Step 2 with B which is the second optimally selected encoding matrix selected by Step 1, and calculating the formula in Step 2 with B which is the third optimally selected encoding matrix if d_{free}³≧d_{free}²≧d_{free}¹ not true and repeating the procedure until d_{free}³≧d_{free}²≧d_{free}¹, before searching in said closed loop path containing four symbol errors, and
d) Repeating the procedure until said encoding matrix B remaining basically unchanged when the number of symbol errors of said closed loop path keeping growing.

13. A method as recited in claim 11 wherein selecting said encoding matrix B with the largest free distance among said closed loop path comprising:
a) Assuming said encoding matrix to be established
$$B = [ \begin{matrix}{b}_{0}^{T} \\ {b}_{1}^{T} \\ ⋮ \\ {b}_{K - 1}^{T}\end{matrix} ] ,$$
where, bₖ^{T}=[b_{k,0}^{T},b_{k,1}^{T}, . . . , b_{k,L-1}^{T}], b_{k,l}^{T}=[b_{k,0}^{l} b_{k,1}^{l} . . . b_{k,N-1}^{l}], k=0,1, . . . , K−1, l=0,1, . . . , L−1,
b) Step 1: arbitrarily selecting a b₀^{T}, and calculating its all {dₗ}₀, l=0,1, . . . . L−1,
c) Step 2: searching the optimal b₁^{T} so that {D}¹≠Ø with constraint condition b₁^{T}b₁* which is the squared Euclidean modulus of b₁^{T} as small as possible, but with node l as many as possible to make sure {dₗ}₁−{dₗ}₀≠Ø, and further assuring said node l differing greatly,
Step 3: searching the optimal b₂^{T} so that {D}²≠Ø with constraint condition b₂^{T}b₂* which is the squared Euclidean modulus of b₂^{T} as small as possible, but with node l as many as possible to make sure {dₗ}₂−{dₗ}₁≠Ø, and further assuring said node l differing greatly, and continuing said above steps, until
e) Step K: searching the optimal b_{K-1}^{T} so that {D}^{K-1}≠Ø with constraint condition b_{K-1}^{T}b_{K-1}* which is the squared Euclidean modulus of b_{K-1}^{T} as small as possible, but with node l as many as possible to make sure {dₗ}_{K-1}−{dₗ}_{K-2}≠Ø, and further assuring said node l differing greatly.

14. A method as recited in claim 13 wherein said method further comprising:
Step K+1: changing the initial b₀^{T} and repeating said Step 1 to said Step K.

15. A method as recited in claim 9 wherein compositing said encoding matrix B also including constructing the high order encoding matrix from the low order encoding matrix, said method comprising:
Generating said high order encoding matrix (K₁K₂, N, L₁L₂) by the following steps if B^{K}^{₁} and B^{K}^{₂} are two known low order encoding matrix (K₁, N, L₁) and (K₂, N, L₂) respectively: B^{K}^{₁}^{K}^{₂}=B^{K}^{₁} [symbol] B^{K}^{₂}, where [symbol] indicating the matrix direct product.

16. A method as recited in claim 9 wherein constructing said high order encoding matrix from said low order encoding matrix, said method comprising:
Generating said high order encoding matrix (K₁+K₂, N, 2 L₁+L₂−1) by the following steps if B^{K}^{₁} and B^{K}^{₂} are two known low order encoding matrix (K₁, N, L₁) and (K₂, N, L₂) respectively:
$${B}^{{K}_{1} + {K}_{2}} = [ \begin{matrix}{B}^{{K}_{1}} {0}_{1} & {0}_{2} \\ {0}_{3} & {B}^{{K}_{2}}\end{matrix} ] ,$$
where 0₁,0₂,0₃ being K₁×L₁−1, K₁×L₂, K₂×(2 L₁−1) order all-zero matrix.

17. A method as recited in claim 9 wherein said maximum likelihood detection algorithm or maximum posteriori probability sequence detection algorithm or fast decoding algorithm is used for detecting said received N-dimensional output coding vector.

18. A method as recited in claim 5 wherein said method further comprising:
a) Compositing said encoding matrix B,
b) Generating multiple signature sequences by expanding said encoding matrix B,
c) Forming multiple data streams for parallel transmission corresponding to multiple signature sequences,
d) Proceeding said convolutional coding between each data stream and the corresponding signature sequence with said coding constraint length L,
e) Forming said N-dimensional output vectors by totaling the result of said K convolutional coding data streams, and
f) Receiving said N-dimensional coding output vectors and taking the sequence detection.

19. A method as recited in claim 18 wherein the process of generating multiple signature sequences by said matrix B comprising said optimal encoding matrix B, as the “root” of the spanning tree, generating signature sequence by [B,B, . . . , B,0] [symbol] H₂ [symbol] H₄ [symbol] . . . [symbol] H₂_{ⁿ}, where H₂_{ⁿ}, n=0,1,2, . . . denoting any orthogonal expansion matrix and 0 being K×L−1 order zero matrix, and [symbol] indicating the direct product.

20. A multiple access transmission method by parallel linear or non-linear multi-access transmission code with coding rate more than one.

21. A method as recited in claim 20 wherein said parallel input bits sequence and output bits sequence have a one-to-one relationship with coding rate more than one.

22. A method as recited in claim 21 wherein said parallel coding is beyond the finite field with all the parallel coding polynomials {\tilde{v}ₖ(x)},k=0,1, . . . , K−1, being linear unrelated.

23. A method as recited in claim 21 wherein all the tap polynomials of said parallel coding bₖ(x),k=0,1, . . . , K−1, are linear unrelated.

24. A method as recited in claim 20 wherein said parallel code comprising the generalized/narrowed linear or non-linear parallel convolutional code with coding rate more than one or any generalized/narrowed linear or non-linear parallel code besides the convolutional code with coding rate more than one.

25. A method as recited in claim 24 wherein the tap coefficients of said parallel coding comprising:
a) The sample value of complex or real Gaussian distribution random variables,
b) The sample value of uniformly distributed random variables within a range of the complex or real plane or {a+jb},a,bε{0,±1,±2, . . . } or other limited non-integer real number, or the tap coefficient located at unit circle or on or above the real axis or imaginary axis.

26. A method as recited in claim 25 wherein said coding tap coefficient belongs to different or rotated or overlapped domains comprising:
different or rotated or overlapped coding domains, different or rotated or overlapped spatial domains, different or rotated or overlapped frequency domains, different or rotated or overlapped time domains or the mixture of above said domains.

27. A method as recited in claim 25 wherein said coding tap of the parallel coding polynomial with linear unrelated coefficient should ensure that the codeword has the largest free distance.

28. A method as recited in claim 24 wherein said method further comprising:
a) Compositing the encoding matrix B containing K coding vectors,
b) Forming K parallel data transmission paths corresponding to the K coding vectors,
c) Processing the convolutional coding between each data path and the corresponding coding vector with coding constraint length L,
d) Forming the N-dimensional output vectors by summing the result of the K convolutional coding data paths,
e) Receiving said N-dimensional coding output vectors and taking the sequence detection, and
f) Said K, N, L being the basic parameters for said parallel coding.

29. A method as recited in claim 28 wherein after establishing said basic parameters K, N, L, the constraints in searching said encoding matrix B with the largest free Euclidean distance become that the elements of matrix B belong to different or rotated or overlapped code domains, spatial domains or frequency domains.

30. A method as recited in claim 29 wherein compositing said encoding matrix B further comprising:
a) Determining the Trellis diagram of the code in accordance with the constraints and the basic parameters of said parallel coding,
b) Determining the closed loop path in accordance with said Trellis diagram of the
code,
c) Selecting said encoding matrix B with the largest free distance among said closed loop path.

31. A method as recited in claim 30 wherein selecting said encoding matrix B with the largest free distance among said closed loop path comprising:
a) Step 1, starting searching from the shortest closed loop path with a vector symbol error, and finding the optimal encoding matrix B among all possible error symbols ∀Xₙ (total species (2^{QK}−1)) under the provisions of the constraints meeting the following formula:
$${d}_{free}^{1} {Max}_{B} {Min}_{∀ {X}_{n} ∈ {χ}^{K} , ∀ B} ‖ {X}_{n}^{T} B ‖ ,$$
and listing the optional encoding matrix B₁,B₂,B₃, . . . according to the descending order of d_{free}¹,
b) Step 2, calculating the following formula with B₁ which is the first optimally selected encoding matrix selected by Step 1 with the closed loop path containing two symbol errors with formula:
$${d}_{free}^{2} {Min}_{{X}_{n} , {X}_{n + {k}_{1}} ∈ {χ}^{K} , ∀ {k}_{1}} ‖ {[ {X}_{n} + {X}_{n + {k}_{1}} ]}^{T} {B}_{1} ‖ ,$$
k₁ε{1,2, . . . , L−2}, ending Step 2 and stepping into Step 3 if d_{free}²≧d_{free}¹, otherwise, calculating above formula with B₂, which is the second optimally selected encoding matrix selected by Step 1, and calculating the above formula with B₃, which is the third optimally selected encoding matrix selected by Step 1 if d_{free}²≧d_{free}¹ not satisfying, and repeating the procedure until d_{free}²≧d_{free}¹, before stepping into Step 3,
c) Step 3: calculating the following formula with B which is the optimal encoding matrix selected by Step 1 and Step 2 with the closed loop path containing three symbol errors with formula:
$${d}_{free}^{3} {Min}_{{X}_{n} , {X}_{n + {k}_{1}} , {X}_{n + {k}_{1} + {k}_{2}} ∈ {χ}^{K} , ∀ {k}_{1} , {k}_{2}} ‖ {[ {X}_{n} + {X}_{n + {k}_{1}} + {X}_{n - {k}_{1} + {k}_{2}} ]}^{T} B ‖ ,$$
k₁,k₂ε{1,2, . . . , L−2}, and ending Step 3 if d_{free}³≧d_{free}²≧d_{free}¹, otherwise calculating the formula in Step 2 with B which is the second optimally selected encoding matrix selected by Step 1, and calculating the formula in Step 2 with B which is the third optimally selected encoding matrix if d_{free}³≧d_{free}²≧d_{free}¹ not satisfying, and repeating the procedure until d_{free}³≧d_{free}²≧d_{free}¹, before searching in said closed loop path containing four symbol errors,
d) Repeating the procedure until said encoding matrix B remaining basically unchanged with the number of symbol errors of said closed loop path keeping growing.

32. A method as recited in claim 30 wherein selecting said encoding matrix B with the largest free distance among said closed loop path comprising:
a) Assuming said encoding matrix to be established being
$$B = [ \begin{matrix}{b}_{0}^{T} \\ {b}_{1}^{T} \\ ⋮ \\ {b}_{K - 1}^{T}\end{matrix} ] ,$$
where, bₖ^{T}=[b_{k,0}^{T},b_{k,1}^{T}, . . . , b_{k,L-1}^{T}], b_{k,l}^{T}=[b_{k,0}^{l} b_{k,1}^{l} . . . b_{k,N-1}^{l}], k=0,1, . . . , K−1, l=0,1, . . . , L−1,
b) Step 1: arbitrarily selecting a b₀, and calculating its all {dₗ}₀, l=0,1, . . . . L−1,
c) Step 2: searching the optimal b₁^{T} so that {D}¹≠Ø, with constraint condition b₁^{T}b₁*, which is the squared Euclidean modulus of b₁^{T} as small as possible, but with node l as many as possible to make sure {dₗ}₁−{dₗ}₀≠Ø, and further assuring said node l differing greatly,
d) Step 3: searching the optimal b₂^{T} so that {D}²≠Ø, with constraint condition b₂^{T}b₂*, which is the squared Euclidean modulus of b₂^{T} as small as possible, but with node l as many as possible to make sure {dₗ}₂−{dₗ}₁≠Ø, and further assuring said node l differing greatly, and continuing above said steps until
e) Step K: searching the optimal b_{K-1}^{T} so that {D}^{K-1}≠Ø, with constraint condition b_{K-1}^{T}b_{K-1}*, which is the squared Euclidean modulus of b_{K-1}^{T} as small as possible, but with node l as many as possible to make sure {dₗ}_{K-1}−{d₁}_{K-2}≠Ø, and further assuring said node l differing greatly.

33. A method as recited in claim 32 wherein said method further comprising:
Step K+1: changing the initial b₀^{T} and repeating said Step 1 to said Step K.

34. A method as recited in claim 28 wherein compositing said encoding matrix B also including constructing the high order encoding matrix from the low order encoding matrix, said method comprising:
Generating said high order encoding matrix (K₁K₂, N, L₁L₂) by the following steps if B^{K}^{₁} and B^{K}^{₂} are two known low order encoding matrix (K₁, N, L₁) and (K₂, N, L₂) respectively: B^{K}^{₁}^{K}^{₂}=B^{K}^{₁} [symbol] B^{K}^{₂}, where [symbol] indicating the matrix direct product.

35. A method as recited in claim 28 wherein constructing said high order encoding matrix from said low order encoding matrix, said method comprising:
Generating said high order encoding matrix (K₁+K₂, N, 2 L₁+L₂−1) by the following steps if B^{K}^{₁} and B^{K}^{₂} are two known low order encoding matrix (K₁,N , L₁) and (K₂, N, L₂) respectively:
$${B}^{{K}_{1} + {K}_{2}} = [ \begin{matrix}{B}^{{K}_{1}} {0}_{1} & {0}_{2} \\ {0}_{3} & {B}^{{K}_{2}}\end{matrix} ] ,$$
where 0₁, 0₂, 0₃ denoting K₁×L₁−1, K₁×L₂, K₂×(2 L₁−1) order all-zero matrix.

36. A method as recited in claim 28 wherein said maximum likelihood detection algorithm or maximum posteriori probability sequence detection algorithm or fast decoding algorithm is used for detecting the received N-dimensional output coding vector.

37. A method as recited in claim 24 wherein said method further comprising:
a) Compositing said encoding matrix B,
b) Generating multiple signature sequences by expanding said encoding matrix B,
c) Forming multiple data streams for parallel transmission corresponding to multiple signature sequences,
d) Processing the convolutional coding between each data stream and the corresponding signature sequence with coding constraint length L,
e) Forming the N-dimensional output vectors by summing the result of the K convolutional coding data streams, and
f) Receiving said N-dimensional coding output vectors and taking the sequence detection.

38. A method as recited in claim 37 wherein the process of generating multiple signature sequences by expanding said matrix B comprising said optimal encoding matrix B, as the “root” of the spanning tree, generating signature sequence by [B, B, . . . , B, 0] [symbol] H₂ [symbol] H₄ [symbol] . . . [symbol] H₂_{ⁿ}, where H₂_{ⁿ}, n=0,1,2, . . . denoting any orthogonal expansion matrix such as Hadmard orthogonal matrix, and 0 being K×L−1 order zero matrix, and [symbol] indicating the direct product.
